(19) United States
(12) Patent Application Publication
(10) Pub. No.: US 2026/0161259 A1
(43) Pub. Date: Jun. 11, 2026

(54) POSITION DETECTION DEVICE, SENSOR, AND PEN

(71) Applicant: Wacom Co., Ltd., Saitama (JP)

(72) Inventors: Yuji SUZUKI, Saitama (JP); Joo Hoon LEE, Saitama (JP); Hiroshi MIZUHASHI, Saitama (JP); Kazuho KAI, Saitama (JP)

(73) Assignee: Wacom Co., Ltd., Saitama (JP)

(21) Appl. No.: 19/538,450

(22) Filed: Feb. 12, 2026

Related U.S. Application Data
(63) Continuation of application No. PCT/JP2024/028800, filed on Aug. 9, 2024.
(60) Provisional application No. 63/519,765, filed on Aug. 15, 2023.
(60) Provisional application No. 63/581,425, filed on Sep. 8, 2023.

(51) Int. Cl. G06F 3/046; G06F 3/0354; G06F 3/041; G06F 3/044

(52) U.S. Cl. CPC G06F 3/046; G06F 3/03545; G06F 3/04166; G06F 3/0442; G06F 3/0446; G06F 2203/04101; G06F 2203/04106

(57) ABSTRACT

A position detection device includes an electromagnetic induction sensor including coil electrodes that detect an alternating magnetic field generated by a pen, based on electromagnetic induction action. The position detection device also includes a plurality of magnetic sensors.

### BACKGROUND

### Technical Field

The present disclosure relates to a position detection device, a sensor, and a pen.

### Description of the Related Art

In recent years, a position input apparatus based on an electromagnetic induction system is used as an input device of a tablet-type personal computer (PC), for example.

The position input apparatus includes, for example, a position indicator and a position detection device that has an input surface for performing a pointing operation or input of characters, diagrams, and the like with use of the position indicator.

The position indicator includes a resonant circuit including a coil and a capacitor.

Meanwhile, the position detection device includes the following components, in order to obtain coordinates of the position indicator in an X-axis direction in an active area AA:
an X sensor coil group including X sensor coils X0 through X4 arranged in an X-direction,
a switch connected to the X sensor coil group, and
an X-axis transmission electrode/reception electrode (TX/RX) circuit that
   generates an alternating magnetic field (a sending-out magnetic field; the same applies hereinafter) by feeding a current through each X sensor coil of the X sensor coil group arranged in the X-axis, in a sending-out period, and,
   in a detection period after the sending-out period, detects, by current or voltage, an electromotive force generated in each of the X sensor coils included in the X sensor coil group by a pen signal (the alternating magnetic field generated by a circuit of the position indicator; the same applies hereinafter) continuously generated even after the sending-out period by the position indicator that has stored energy in the resonant circuit in the sending-out period.

Similarly, the position detection device includes the following components, in order to obtain coordinates of the position indicator in a Y-axis direction:
a Y sensor coil group including Y sensor coils Y0 through Y4 arranged in a Y direction,
a switch connected to the Y sensor coil group, and
a Y-axis TX/RX circuit that
   generates a sending-out magnetic field by feeding a current through each Y sensor coil of the Y sensor coil group arranged in the Y-axis, in the sending-out period, and,
   in a detection period after the sending-out period, detects, by current or voltage, an electromotive force generated in each of the Y sensor coils included in the Y sensor coil group by a pen signal continuously generated even after the sending-out period by the position indicator that has stored energy in the resonant circuit in the sending-out period.

It is known to use a stylus pen (hereinafter generically referred to as a pen) as a position indicator configured to be capable of transmitting a signal for position detection (position signal) and a signal (data signal) including various kinds of data as exemplified by specific identification (ID) and a pen pressure to the sensor controller, in order to obtain the coordinates of the position indicator in the X-axis direction and the Y-axis direction in the active area AA described above.

In the following description, a signal transmitted by the pen to the sensor controller will generically be referred to as a “downlink signal.”

When a user uses a pen to input any character or drawing, the pen gradually approaches a touch surface of an electronic device including a sensor controller, and eventually, a core body of the pen comes into contact with the touch surface. Input of any character or drawing by a pen is allowed when the core body of the pen is in contact with the touch surface.

In the following description, a state in which the core body of the pen is in contact with the touch surface is referred to as a “contact” state, while a state in which the core body of the pen is yet to come into contact with the touch surface is referred to as a “hovering” state.

As one type of such a technology, a pen that reduces the transmission strength of the position signal in a contact state compared to that in a hovering state is disclosed (see, for example, U.S. Pat. No. 8,773,405 (hereinafter referred to as “Patent Document 1”)).

Here, when a signal/noise (S/N) ratio of the downlink signal received by the sensor within the touch surface is compared between the case when the pen is in a hovering state and when the pen is in a contact state with the sensor, the signal level is smaller in the case in which the pen is in the hovering state. This is because the distance between the sensor and the pen is greater and the amount of attenuation of the downlink signal is greater in the case in which the pen is in the hovering state. As a result, in the case in which the pen is in the hovering state, a reception error of the downlink signal by the sensor controller sometimes occurs, demanding improvements to be made.

In contrast, according to the technology described in Patent Document 1, the reception strength of the downlink signal when the pen is in the hovering state is greater than when the pen is in the contact state, and hence, the possibility of a reception error of the downlink signal by the sensor controller occurring when the pen is in the hovering state may be reduced.

However, adopting the technology described in Patent Document 1 had such a problem that a special transmitter compatible with a variable transmission strength needs to be mounted in a pen.

### BRIEF SUMMARY

The present disclosure has been made in view of the problems described above, and the disclosure provides a position detection device, a sensor, and a pen that improves the position detection accuracy when the pen is in the hovering state, at low cost.

Mode 1: one or more embodiments of the present disclosure propose a position detection device that includes an electromagnetic induction sensor including coil electrodes that detect an alternating magnetic field generated by a pen, based on electromagnetic induction action, and a plurality of magnetic sensors.

Mode 2: One or more embodiments of the present disclosure propose a position detection device that detects a position of a pen, based on electromagnetic induction action, in which the pen is provided with a permanent magnet together with a coil that generates an alternating magnetic field. The position detection device includes an electromagnetic induction sensor in which coil electrodes for detecting the alternating magnetic field generated by the pen, based on electromagnetic induction action, are arranged side by side, a plurality of first magnetic sensors provided in a detection area of the electromagnetic induction sensor, and an integrated circuit that detects the alternating magnetic field generated by the pen and identifies two-dimensional position information of the pen, by supplementarily using output of one or more of the first magnetic sensors that have detected a magnetic field generated by the permanent magnet.

Mode 3: One or more embodiments of the present disclosure propose a position detection device that detects a position of a pen, based on electromagnetic induction action, in which the pen is provided with a permanent magnet together with a coil that generates an alternating magnetic field. The position detection device includes an electromagnetic induction sensor in which coil electrodes for detecting the alternating magnetic field generated by the pen, based on electromagnetic induction action, are arranged side by side, a plurality of first magnetic sensors provided in a detection area of the electromagnetic induction sensor, a second magnetic sensor provided in a vicinity of an outer periphery of the detection area of the electromagnetic induction sensor, and an integrated circuit that detects the alternating magnetic field generated by the pen and identifies two-dimensional position information of the pen by supplementarily using output of one or more of the first magnetic sensors and the second magnetic sensor that have detected a magnetic field generated by the permanent magnet.

Mode 4: One or more embodiments of the present disclosure propose a sensor including an electromagnetic induction sensor including coil electrodes that detect an alternating magnetic field generated by a pen, based on electromagnetic induction action, and a plurality of magnetic sensors.

Mode 5: One or more embodiments of the present disclosure propose a pen including a coil that generates an alternating magnetic field and a permanent magnet.

One or more embodiments of the present disclosure have an advantageous effect of improving the position detection accuracy in a case where the pen is in the hovering state, at low cost.

### BRIEF DESCRIPTION OF THE SEVERAL VIEWS OF THE DRAWINGS

FIG. 1 is a diagram illustrating a general configuration of a position detection device according to a first embodiment of the present disclosure that is configured to be able to recognize a position of a pen even at a farther distance than in the related art when the pen is hovering above an electromagnetic induction sensor in the position detection device;

FIG. 2A is a perspective view illustrating a structure of a position detection device according to the first embodiment of the present disclosure;

FIG. 2B is a cross sectional view of FIG. 2A as viewed from A-A′ in the position detection device according to the first embodiment of the present disclosure;

FIG. 3A is a perspective view illustrating a structure of a position detection device according to the first embodiment of the present disclosure;

FIG. 3B is a cross sectional view of FIG. 3A as viewed from A-A′ in the position detection device according to the first embodiment of the present disclosure;

FIG. 4A is a perspective view illustrating a structure of a position detection device according to the first embodiment of the present disclosure;

FIG. 4B is a cross sectional view of FIG. 4A as viewed from A-A′ in the position detection device according to the first embodiment of the present disclosure;

FIG. 5A is a perspective view illustrating a structure of a position detection device according to the first embodiment of the present disclosure;

FIG. 5B is a cross sectional view of FIG. 5A as viewed from A-A′ in the position detection device according to the first embodiment of the present disclosure;

FIG. 6 is a diagram illustrating a form of wiring in a position detection device according to the first embodiment of the present disclosure;

FIG. 7 is a diagram illustrating a form of wiring in a position detection device according to the first embodiment of the present disclosure;

FIG. 8A is a conceptual diagram of a coordinate deriving operation using an electromagnetic induction system that derives a position of a pen including an LC resonant circuit by distribution of an alternating magnetic field generated by energy applied by an alternating magnetic field to the pen, in a position detection device according to an example in the related art;

FIG. 8B is a conceptual diagram of a coordinate deriving operation using a capacitance system that uses a mutual capacitance of a TX and an RX in the position detection device according to the example in the related art;

FIG. 9A is a schematic diagram illustrating the coordinate deriving operation in a case where the pen is hovering HV (detecting an object in the air), based on the concept illustrated in FIGS. 8A and 8B, in the position detection device according to the example in the related art;

FIG. 9B is a diagram illustrating a concept of the coordinate deriving operation that is to be performed at the time when the pen including a permanent magnet is hovering HV by a position detection device according to a second embodiment of the present disclosure that includes magnetic sensors;

FIG. 10A is a diagram illustrating a shape of the permanent magnet included in the pen, in a simplified manner;

FIGS. 10B1 through 10B4 are each a schematic diagram illustrating a form of arrangement of the magnetic sensor(s) in the position detection device according to the second embodiment of the present disclosure;

FIG. 11A is a diagram illustrating an influence caused by geomagnetism on coordinate derivation in a case where the magnetic sensor and the permanent magnet are at a relatively short distance, in the position detection device according to the second embodiment of the present disclosure;

FIG. 11B is a diagram illustrating an influence caused by geomagnetism on coordinate derivation in a case where the magnetic sensor and the permanent magnet are at a relatively long distance, in the position detection device according to the second embodiment of the present disclosure;

FIG. 12A is a diagram illustrating an example of the permanent magnet being detected by the magnetic sensors illustrated in FIGS. 11A and 11B in the position detection device according to the second embodiment of the present disclosure;

FIG. 12B is a diagram illustrating an example of the permanent magnet being detected by the magnetic sensors illustrated in FIGS. 11A and 11B in the position detection device according to the second embodiment of the present disclosure;

FIG. 13 is a diagram illustrating an example of the permanent magnet being detected by the magnetic sensor illustrated in FIGS. 11A and 11B in the position detection device according to the second embodiment of the present disclosure;

FIG. 14 is a diagram illustrating an example of the permanent magnet being detected by the magnetic sensor illustrated in FIGS. 11A and 11B in the position detection device according to the second embodiment of the present disclosure;

FIG. 15A is a diagram illustrating a case where there are two geomagnetic sensors for geomagnetism in the position detection device according to the second embodiment of the present disclosure;

FIG. 15B is a diagram illustrating a case where there are two geomagnetic sensors for geomagnetism in the position detection device according to the second embodiment of the present disclosure and a pen in the vicinity thereof;

FIG. 16A is a diagram illustrating a case where there is only geomagnetism, in the position detection device according to the second embodiment of the present disclosure;

FIG. 16B is a diagram illustrating a case where there is only geomagnetism and an object that is not a pen but has a magnetic field is in the vicinity of the magnetic sensor, in the position detection device according to the second embodiment of the present disclosure;

FIGS. 17A and 17B are each a diagram illustrating processing in the case of FIG. 16A in the position detection device according to the second embodiment of the present disclosure;

FIGS. 18A and 18B are each a diagram illustrating processing in the case of FIG. 16B in the position detection device according to the second embodiment of the present disclosure;

FIG. 19 is a flowchart illustrating specific processing in FIGS. 17A through 18B in the position detection device according to the second embodiment of the present disclosure;

FIG. 20 is a diagram illustrating processing in an integrated circuit in a position detection device according to a third embodiment of the present disclosure;

FIG. 21 is a diagram illustrating processing in the integrated circuit in the position detection device according to the third embodiment of the present disclosure;

FIG. 22 is a flowchart illustrating specific processing in FIGS. 20 and 21 in the position detection device according to the third embodiment of the present disclosure;

FIG. 23 is a diagram illustrating a configuration of a pen assumed to be used with a position detection device according to a fourth embodiment of the present disclosure;

FIGS. 24A through 24D are each a cross sectional view of an active capacitance pen assumed to be used with the position detection device according to the fourth embodiment of the present disclosure using a capacitive induction system;

FIG. 25 is a schematic diagram of a case where the pen including the permanent magnet is tilted with respect to the position detection device according to the fourth embodiment of the present disclosure that includes one or more magnetic sensors;

FIG. 26A is a diagram illustrating examples of numerical values that are detected by decomposing the magnetic field of the pen into an X-axis, a Y-axis, and a Z-axis of the magnetic sensor in a case where the pen is vertical to the magnetic sensor in the position detection device according to the fourth embodiment of the present disclosure;

FIG. 26B is a diagram illustrating examples of numerical values that are detected by decomposing the magnetic field of the pen into the X-axis, the Y-axis, and the Z-axis of the magnetic sensor in a case where the pen is titled at a desired angle by a user, with respect to the position detection device according to the fourth embodiment of the present disclosure;

FIG. 27 is a diagram illustrating examples of numerical values that are detected by decomposing a magnetic field in a case of rotating the pen in an A direction (counterclockwise) into the X-axis, the Y-axis, and the Z-axis of the magnetic sensor in the position detection device according to the fourth embodiment of the present disclosure;

FIG. 28 is a diagram illustrating examples of numerical values that are detected by decomposing a magnetic field in a case of rotating the pen in a B direction (clockwise) into the X-axis, the Y-axis, and the Z-axis of the magnetic sensor in the position detection device according to the fourth embodiment of the present disclosure;

FIG. 29 is a diagram illustrating a configuration of a position detection device according to a fifth embodiment of the present disclosure;

FIG. 30 is a flowchart illustrating processing in the position detection device according to the fifth embodiment of the present disclosure;

FIG. 31 is a diagram illustrating a configuration of a position detection device according to a sixth embodiment of the present disclosure;

FIG. 32 is a flowchart illustrating processing in the position detection device according to the sixth embodiment of the present disclosure;

FIG. 33 is a diagram illustrating a configuration of a position detection device according to a seventh embodiment of the present disclosure;

FIG. 34 is a flowchart illustrating processing in the position detection device according to the seventh embodiment of the present disclosure;

FIG. 35A is a diagram illustrating pen signal levels in a case where the pen has a tilt angle of 90 degrees and an angle of 0 degrees with respect to a normal to a sensor plane in areas in which TX sensor coils cross RX sensor coils in the position detection device according to the seventh embodiment of the present disclosure;

FIG. 35B is a diagram obtained by organizing the pen signal level values illustrated in FIG. 35A by moving averages;

FIG. 35C is a diagram illustrating pen signal level data illustrated in FIG. 35B, in a three-dimensional (3D) view, with respect to the position detection device according to the seventh embodiment of the present disclosure;

FIG. 36A is a diagram illustrating pen signal levels in a case where the pen has a tilt angle of degrees with respect to a normal to a sensor plane and an angle of 90 degrees with respect to the sensor plane in areas where the TX sensor coils cross the RX sensor coils in the position detection device according to the seventh embodiment of the present disclosure;

FIG. 36B is a diagram obtained by organizing the pen signal level values illustrated in FIG. 36A by moving averages;

FIG. 36C is a diagram illustrating the pen signal level data illustrated in FIG. 36B, in a 3D view, with respect to the position detection device according to the seventh embodiment of the present disclosure;

FIG. 37A is a diagram illustrating pen signal levels in a case where the pen has a tilt angle of 30 degrees with respect to the normal to the sensor plane and an angle of 0 degrees with respect to the sensor plane in areas in which the TX sensor coils cross the RX sensor coils in the position detection device according to the seventh embodiment of the present disclosure;

FIG. 37B is a diagram obtained by organizing the pen signal level values illustrated in FIG. 37A by moving averages;

FIG. 37C is a diagram illustrating pen signal level data illustrated in FIG. 37B, in a 3D view, with respect to the position detection device according to the seventh embodiment of the present disclosure;

FIG. 38A is a diagram illustrating pen signal levels in a case where the pen has a tilt angle of 30 degrees with respect to the normal to the sensor plane and an angle of 45 degrees with respect to the sensor plane in areas in which the TX sensor coils cross the RX sensor coils in the position detection device according to the seventh embodiment of the present disclosure;

FIG. 38B is a diagram obtained by organizing the pen signal level values illustrated in FIG. 38A by moving averages;

FIG. 38C is a diagram illustrating pen signal level data illustrated in FIG. 38B, in a 3D view, with respect to the position detection device according to the seventh embodiment of the present disclosure;

FIG. 39A is a diagram illustrating pen signal levels in a case where the pen has a tilt angle of 30 degrees with respect to the normal to the sensor plane and an angle of −45 degrees with respect to the sensor plane in areas in which the TX sensor coils cross the RX sensor coils in the position detection device according to the seventh embodiment of the present disclosure;

FIG. 39B is a diagram obtained by organizing the pen signal level values illustrated in FIG. 39A, by moving averages; and

FIG. 39C is a diagram illustrating the pen signal level data illustrated in FIG. 39B, in a 3D view, in the position detection device according to the seventh embodiment of the present disclosure.

### DETAILED DESCRIPTION

Embodiments of the present disclosure will hereinafter be described with use of FIGS. 1 through 39C.

### First Embodiment

A position detection device 10 according to a first embodiment of the present disclosure is first described with use of FIGS. 1 through 7.

### Configuration of Position Detection Device 10

As illustrated in FIG. 1, the position detection device 10 includes an electromagnetic induction sensor 1, which includes coil electrodes E that detect an alternating magnetic field generated by a pen, based on electromagnetic induction action, and a plurality of magnetic sensors 2. Moreover, the position detection device 10 includes a TX circuit, a switch, a TX sensor coil group (first sensor coil group), an RX sensor coil group (second sensor coil group), an RX circuit, and a peripheral circuit such as an amplifier, none of which are illustrated.

As illustrated in FIG. 1, the magnetic sensors 2 are arranged at positions where the magnetic sensors 2 do not overlap the coil electrodes E in plan view, for example. Moreover, as illustrated in FIG. 1, for example, each of the magnetic sensors 2 is provided at a position where the magnetic sensor 2 is not affected by the magnetic field generated by a current flowing through the coil electrode E.

Note that, in the present embodiment and subsequent embodiments, description is given using the electromagnetic induction sensor 1 as an example; however, the description is also applicable to mini light emitting diode (LED) substrates, an active capacitance system (AES), and the like.

The TX sensor coil group (first sensor coil group) includes a plurality of conducting wires arranged side by side in a first direction (X-axis direction) of the sensor, and TX sensor coils included in the TX sensor coil group are formed by, for example, rectangular loop coils. Moreover, the TX sensor coils included in the TX sensor coil group are, for example, arranged side by side at equal intervals.

The RX sensor coil group (second sensor coil group) includes a plurality of conducting wires arranged side by side in a second direction (Y-axis direction) intersecting the first direction (X-axis direction) of the sensor, and RX sensor coils included in the RX sensor coil group are formed by, for example, rectangular loop coils. Moreover, the RX sensor coils included in the RX sensor coil group are, for example, arranged side by side at equal intervals.

The electromagnetic induction sensor 1 includes the TX sensor coil group and the RX sensor coil group. The electromagnetic induction sensor 1 generates an alternating magnetic field, and also receives a pen signal that is a response alternating magnetic field from a pen 100, to acquire the level of the pen signal. The TX circuit functions as an alternating magnetic field generation section that transmits a signal through the switch to the TX sensor coil group and causes the TX sensor coil group to generate an alternating magnetic field. Specifically, in the position detection device 10 according to the present embodiment, TX sensor coils T0 through T4 are connected to the TX circuit and used for generating an alternating magnetic field but not for detecting a pen signal.

The RX circuit functions as a pen signal level acquiring circuit that uses a plurality of electrodes of the electromagnetic induction sensor (RX sensor coil group) 1 to receive a pen signal that is a response alternating magnetic field from the pen that is stored according to the alternating magnetic field and acquire the level of the pen signal. Specifically, electromagnetic induction sensor coils R0 through R4 are connected to the RX circuit and used for detecting a pen signal but not for generating a sending-out magnetic field.

Moreover, the RX circuit also functions as an information deriving circuit that uses two-dimensional distribution of levels of pen signals at each point of intersection between the plurality of conducting wires of the TX sensor coil group and a plurality of electrodes of the electromagnetic induction sensor coil group (RX sensor coil group), to derive information regarding the position of the pen.

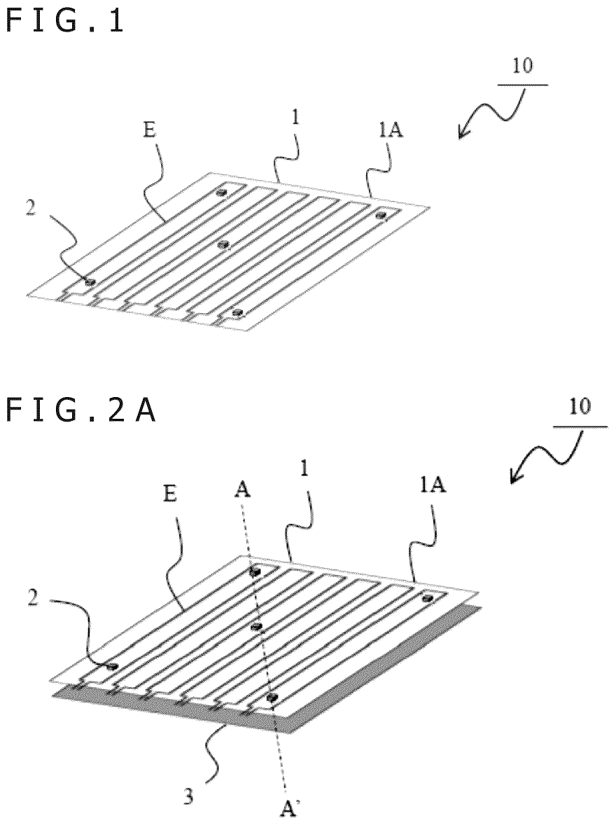

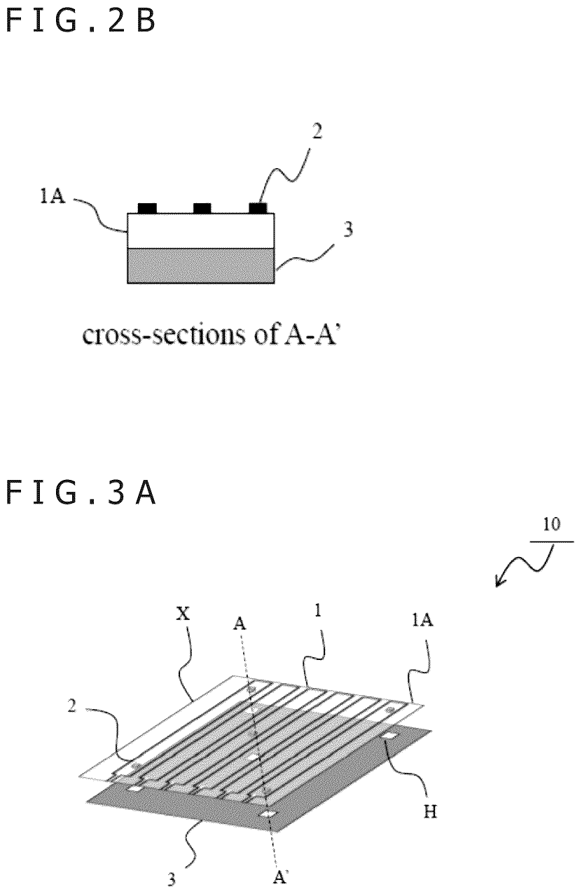

As illustrated in FIG. 2A, the electromagnetic induction sensor 1 and the magnetic sensors 2 are mounted on an upper surface of an electromagnetic induction sensor substrate 1A, for example. In this instance, the magnetic sensors 2 are provided at positions where the magnetic sensors 2 do not overlap the coil electrodes E in plan view, as illustrated in FIG. 2A. The magnetic sensors 2 are mounted on the upper surface of the electromagnetic induction sensor substrate 1A as illustrated in FIG. 2B.

On a lower portion of the electromagnetic induction sensor substrate 1A, a magnetic sheet 3 is provided. The magnetic sheet 3 prevents influence from a magnet or a magnetic metal from being caused on the electromagnetic induction sensor 1 and the magnetic sensors 2.

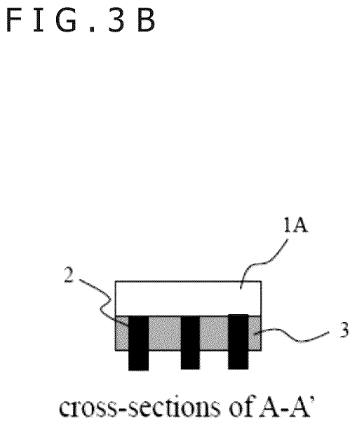

As illustrated in FIG. 3A, for example, the electromagnetic induction sensor 1 is mounted on the upper surface of the electromagnetic induction sensor substrate 1A, and the magnetic sensors 2 are mounted on a lower surface of the electromagnetic induction sensor substrate 1A. Such a structure is effective when the magnetic sensors 2 cannot be mounted on the upper surface of the electromagnetic induction sensor substrate 1A and when the upper surface of the electromagnetic induction sensor substrate 1A is to be kept flat.

As another example, the magnetic sensors 2 are, as illustrated in FIG. 3A, provided at positions where the magnetic sensors 2 do not overlap the coil electrodes E in plan view.

As illustrated in FIGS. 3A and 3B, the magnetic sheet 3 is stacked on the lower portion of the electromagnetic induction sensor substrate 1A, and has through holes H at portions corresponding to the positions where the magnetic sensors 2 are mounted in plan view. The magnetic sensor 2 is provided in such a manner that an end portion of the magnetic sensor 2 protrudes above the through hole H from the lower portion of the electromagnetic induction sensor substrate 1A. This is due to the magnetic sensor 2 being thicker than the magnetic sheet 3. Moreover, adopting such a structure is also effective in terms of maintaining the characteristics of the magnetic sheet 3 and keeping the lower surface of the electromagnetic induction sensor substrate 1A flat.

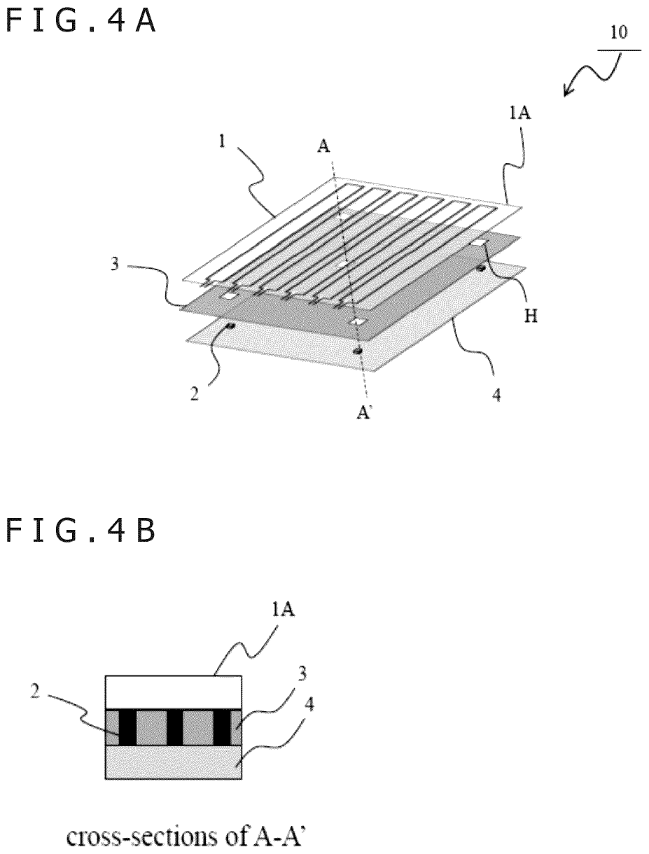

As another example, as illustrated in FIG. 4A, a substrate (electromagnetic induction sensor substrate 1A) on which the electromagnetic induction sensor 1 is mounted and a substrate (magnetic sensor substrate 4) on which the magnetic sensors 2 are mounted are different substrates, for example. The sensor illustrated in FIG. 4A has a structure in which the magnetic sheet 3 is stacked above the magnetic sensor substrate 4 on which the magnetic sensors 2 are mounted, and the electromagnetic induction sensor substrate 1A, the magnetic sheet 3, and the magnetic sensor substrate 4 are stacked in this order from top to bottom. The magnetic sheet 3 is provided with the through holes H at portions corresponding to the positions where the magnetic sensors 2 are mounted in plan view.

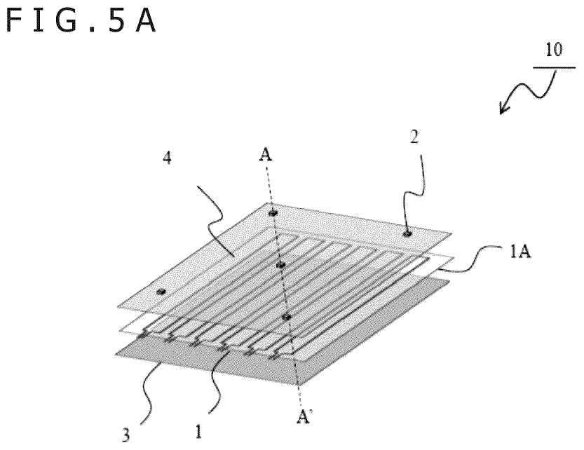

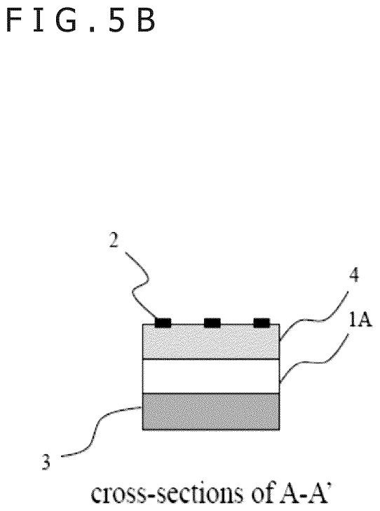

As another example, as illustrated in FIG. 5A, the substrate (electromagnetic induction sensor substrate 1A) on which the electromagnetic induction sensor 1 is mounted and the substrate (magnetic sensor substrate 4) on which the magnetic sensors 2 are mounted are different substrates. As illustrated in FIGS. 5A and 5B, the sensor includes the magnetic sensor substrate 4, the electromagnetic induction sensor substrate 1A, and the magnetic sheet 3 stacked in this order from top to bottom.

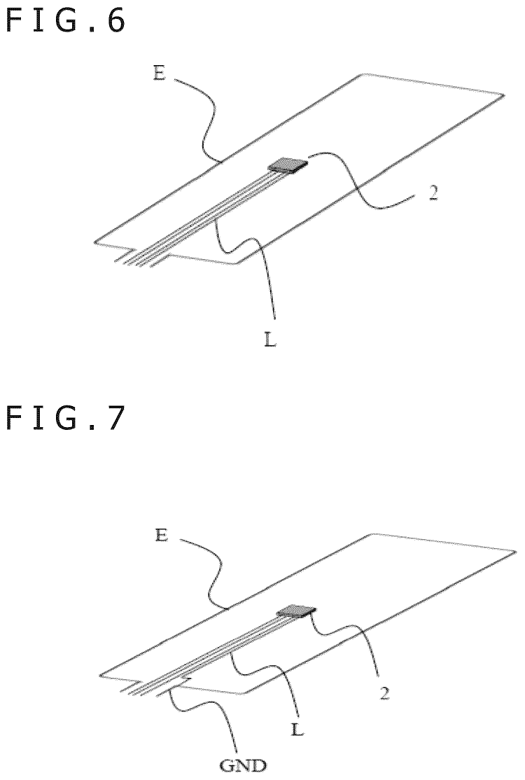

As illustrated in FIG. 6, in a case where the electromagnetic induction sensor 1 and the magnetic sensors 2 are mounted on the electromagnetic induction sensor substrate 1A on which the electromagnetic induction sensor 1 is mounted, a signal wire, a ground wire, and a power supply wire from the electromagnetic induction sensor 1 and a signal wire, a ground wire, and a power supply wire from the magnetic sensors 2 are routed to the same layer in the electromagnetic induction sensor substrate 1A. This makes it possible to prevent interference between the wires from the electromagnetic induction sensor 1 and the wires from the magnetic sensors 2.

As illustrated in FIG. 7, in a case where the electromagnetic induction sensor 1 and the magnetic sensors 2 are mounted on the electromagnetic induction sensor substrate 1A on which the electromagnetic induction sensor 1 is mounted, the ground wire from the electromagnetic induction sensor 1 and the ground wire from the magnetic sensors 2 are shared. This makes it possible to prevent interference between the wires from the electromagnetic induction sensor 1 and the wires from the magnetic sensors 2 and also reduce the number of wires connected to the outside.

### Action and Effect

As described above, the position detection device 10 according to the present embodiment includes the electromagnetic induction sensor 1, which includes the coil electrodes E that detect the alternating magnetic field generated by a pen, based on electromagnetic induction action, and the plurality of magnetic sensors 2.

That is, even in a case where the strength of the alternating magnetic field generated by a pen according to electromagnetic induction action is small, as in the case where the pen is in a hovering state, providing a plurality of magnetic sensors 2 makes it possible to accurately detect that the pen is in a hovering state. Hence, the position detection accuracy in the case where the pen is in the hovering state can be improved at low cost.

Moreover, seeking improved position detection accuracy in the case where the pen is in the hovering state also leads to seeking improved coordinate derivation accuracy in a case where the core body of the pen comes into contact with the touch surface.

In the position detection device 10 according to the present embodiment, the magnetic sensors 2 are provided at positions where the magnetic sensors 2 do not overlap the coil electrodes E in plan view. That is, the magnetic sensors 2 are provided at positions where the magnetic sensors 2 do not overlap the coil electrodes E in plan view and are hence less affected by the magnetic field generated by the coil electrodes E. Thus, allowing the magnetic sensors 2 to be less affected by the magnetic field generated by the coil electrodes E can reduce false detection as much as possible.

Moreover, reducing false detection of the magnetic sensors 2 as much as possible makes it possible to accurately detect that the pen is in a hovering state. Hence, the position detection accuracy in the case where the pen is in the hovering state can be improved at low cost. Further, seeking improved position detection accuracy in the case where the pen is in the hovering state also leads to seeking improved coordinate derivation accuracy in the case where the core body of the pen comes into contact with the touch surface.

In the position detection device 10 according to the present embodiment, the magnetic sensors 2 are provided at positions where the magnetic sensors 2 are not affected by the magnetic field generated by a current flowing through the coil electrodes E. That is, the magnetic sensors 2 are provided at positions where the magnetic sensors 2 are not affected by the magnetic field generated by a current flowing through the coil electrodes E. Thus, allowing the magnetic sensors 2 to be less affected by the magnetic field generated by the coil electrodes E can reduce false detection of the magnetic sensors 2 as much as possible. Moreover, reducing false detection of the magnetic sensors 2 as much as possible makes it possible to accurately detect that the pen is in the hovering state. Hence, the position detection accuracy in the case where the pen is in the hovering state can be improved at low cost.

Further, seeking improved position detection accuracy in the case where the pen is in the hovering state also leads to seeking improved coordinate derivation accuracy in the case where the core body of the pen comes into contact with the touch surface.

In the position detection device 10 according to the present embodiment, the electromagnetic induction sensor 1 and the magnetic sensors 2 are mounted on the electromagnetic induction sensor substrate 1A on which the electromagnetic induction sensor 1 is mounted. That is, the electromagnetic induction sensor 1 and the magnetic sensors 2 are mounted on the same electromagnetic induction sensor substrate 1A. Hence, a new substrate is not needed, so that an increase in the cost of the position detection device 10 can be suppressed.

Moreover, no need for a new substrate can restrain the thickness of the sensor from increasing. This can improve the design of the sensor.

In the position detection device 10 according to the present embodiment, the magnetic sheet 3 is stacked on the lower portion of the electromagnetic induction sensor substrate 1A and is provided with the through holes H at portions corresponding to the positions where the magnetic sensors 2 are mounted in plan view. That is, the sensor includes the electromagnetic induction sensor substrate 1A on which the electromagnetic induction sensor 1 and the magnetic sensors 2 are mounted and the magnetic sheet 3 that are stacked in this order from top to bottom.

Hence, stacking the magnetic sheet 3 on the lower portion of the electromagnetic induction sensor substrate 1A can prevent the electromagnetic induction sensor 1 and the magnetic sensors 2 from being affected by the magnet or the magnetic metal near the lower portion.

Moreover, the magnetic sheet 3 is provided with the through holes H at portions corresponding to the positions where the magnetic sensors 2 are mounted in plan view. This is because, when an upper end portion of each of the magnetic sensors 2 is covered with the magnetic sheet 3, magnetism from an upper portion spreads in an in-plane direction, and the detection accuracy of the magnetic sensors 2 deteriorates.

In view of this, providing the through holes H at portions corresponding to the positions where the magnetic sensors 2 are mounted in plan view in the magnetic sheet 3 can prevent the detection accuracy of the magnetic sensors 2 from deteriorating.

Accordingly, seeking improved position detection accuracy in the case where the pen is in the hovering state also leads to seeking improved coordinate derivation accuracy in the case where the core body of the pen comes into contact with the touch surface.

In the position detection device 10 according to the present embodiment, the electromagnetic induction sensor substrate 1A on which the electromagnetic induction sensor 1 is mounted and the magnetic sensor substrate 4 on which the magnetic sensors 2 are mounted are different substrates. That is, the electromagnetic induction sensor 1 and the magnetic sensors 2 are separated from each other by a predetermined distance.

Hence, making the electromagnetic induction sensor substrate 1A on which the electromagnetic induction sensor 1 is mounted and the magnetic sensor substrate 4 on which the magnetic sensors 2 are mounted different substrates can prevent the magnetic sensors 2 from being affected by any magnet or magnetic metal near the electromagnetic induction sensor 1 and the magnetic sensors 2. This can improve the position detection accuracy in the case where the pen is in the hovering state, at low cost.

Moreover, seeking improved position detection accuracy in the case where the pen is in the hovering state also leads to seeking improved coordinate derivation accuracy in the case where the core body of the pen comes into contact with the touch surface.

In the position detection device 10 according to the present embodiment, the sensor includes the electromagnetic induction sensor substrate 1A, the magnetic sheet 3, and the magnetic sensor substrate 4 that are stacked in this order from top to bottom, and the magnetic sheet 3 is provided with the through holes H at portions corresponding to the positions where the magnetic sensors 2 are mounted in the magnetic sensor substrate 4 in plan view. Specifically, the electromagnetic induction sensor substrate 1A, the magnetic sheet 3, and the magnetic sensor substrate 4 are stacked in this order from top to bottom, and the magnetic sheet 3 that is provided above the magnetic sensor substrate 4 is provided with the through holes H at portions corresponding to the positions where the magnetic sensors 2 are mounted in the magnetic sensor substrate 4 in plan view.

Hence, an influence of the magnetism from around the upper portion of the sensor on the magnetic sensors 2 can be kept to the minimum. Accordingly, providing the magnetic sheet 3 that is stacked above the magnetic sensors 2 with the through holes H at portions corresponding to the positions where the magnetic sensors 2 are mounted in plan view can prevent the detection accuracy of the magnetic sensors 2 from deteriorating.

Moreover, seeking improved position detection accuracy in the case where the pen is in the hovering state also leads to seeking improved coordinate derivation accuracy in the case where the core body of the pen comes into contact with the touch surface.

In the position detection device 10 according to the present embodiment, the sensor includes the magnetic sensor substrate 4, the electromagnetic induction sensor substrate 1A, and the magnetic sheet 3 that are stacked in this order from top to bottom. That is, the electromagnetic induction sensor substrate 1A is stacked on the lower side of the magnetic sensor substrate 4, and the magnetic sheet 3 is stacked on the lower side of the electromagnetic induction sensor substrate 1A.

Hence, the magnetic sensor substrate 4 is isolated through the electromagnetic induction sensor substrate 1A and the magnetic sheet 3 from the space in which metal or a member or component that generates magnetism in a product condition is arranged. Accordingly, a magnetic influence from the metal or the member or component that generates magnetism in a product condition on the magnetic sensors 2 can be kept to the minimum, preventing the detection accuracy of the magnetic sensors 2 from deteriorating.

Moreover, seeking improved position detection accuracy in the case where the pen is in the hovering state also leads to seeking improved coordinate derivation accuracy in the case where the core body of the pen comes into contact with the touch surface.

In the position detection device 10 according to the present embodiment, in a case where the electromagnetic induction sensor 1 and the magnetic sensors 2 are mounted on the electromagnetic induction sensor substrate 1A on which the electromagnetic induction sensor 1 is mounted, the signal wire, the ground wire, and the power supply wire from the electromagnetic induction sensor 1 and the signal wire, the ground wire, and the power supply wire from the magnetic sensors 2 are routed to the same layer in the electromagnetic induction sensor substrate 1A.

That is, as illustrated in FIG. 6, in a case where the electromagnetic induction sensor 1 and the magnetic sensors 2 are mounted on the electromagnetic induction sensor substrate 1A on which the electromagnetic induction sensor 1 is mounted, the signal wire, the ground wire, and the power supply wire from the electromagnetic induction sensor 1 and the signal wire, the ground wire, and the power supply wire from the magnetic sensors 2 are routed to the same layer in the electromagnetic induction sensor substrate 1A. Hence, capacitive coupling between the wires from the electromagnetic induction sensor 1 and the wires from the magnetic sensors 2 is prevented, so that magnetic interference between the wires from the electromagnetic induction sensor 1 and the wires from the magnetic sensors 2 can also be prevented. This can prevent the detection accuracy of the magnetic sensors 2 from deteriorating.

Accordingly, seeking improved position detection accuracy in the case where the pen is in the hovering state also leads to seeking improved coordinate derivation accuracy in the case where the core body of the pen comes into contact with the touch surface.

In the position detection device 10 according to the present embodiment, in a case where the electromagnetic induction sensor 1 and the magnetic sensors 2 are mounted on the electromagnetic induction sensor substrate 1A on which the electromagnetic induction sensor 1 is mounted, the ground wire from the electromagnetic induction sensor 1 and the ground wire from the magnetic sensors 2 are shared. That is, as illustrated in FIG. 7, in a case where the electromagnetic induction sensor 1 and the magnetic sensors 2 are mounted on the electromagnetic induction sensor substrate 1A on which the electromagnetic induction sensor 1 is mounted, the ground wire from the electromagnetic induction sensor 1 and the ground wire from the magnetic sensors 2 are shared.

Hence, capacitive coupling between the wires from the electromagnetic induction sensor 1 and the wires from the magnetic sensors 2 is prevented, so that magnetic interference between the wires from the electromagnetic induction sensor 1 and the wires from the magnetic sensors 2 can be prevented, also reducing the number of wires connected to the outside. This can prevent the detection accuracy of the magnetic sensors 2 from deteriorating.

Accordingly, seeking improved position detection accuracy in the case where the pen is in the hovering state also leads to seeking improved coordinate derivation accuracy in the case where the core body of the pen comes into contact with the touch surface.

### Second Embodiment

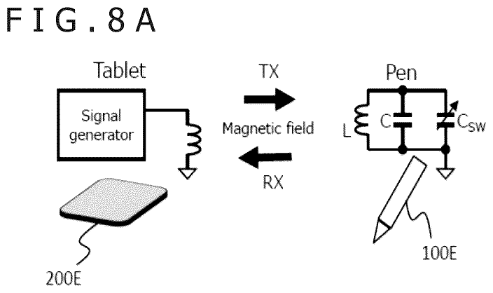

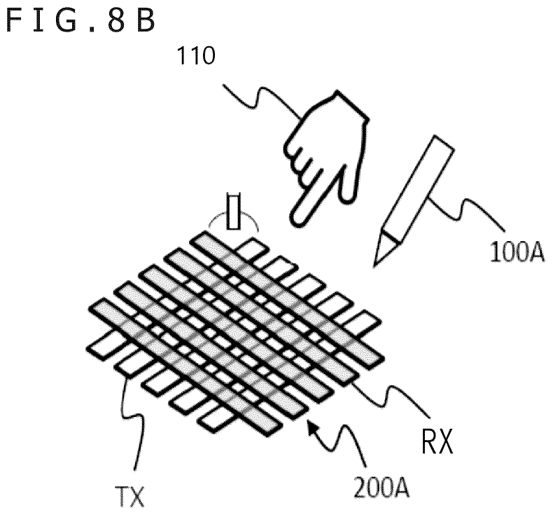

Next, a position detection device 200 according to a second embodiment of the present disclosure is described with use of FIGS. 8A through 19.

### Position Detection Device 200

The position detection device 200 according to the present embodiment includes a pen provided with a permanent magnet together with a coil that generates an alternating magnetic field, the electromagnetic induction sensor 1 in which coil electrodes for detecting an alternating magnetic field generated by the pen, based on electromagnetic induction action, are arranged side by side, a plurality of first magnetic sensors 300 provided in the electromagnetic induction sensor 1, and an integrated circuit that detects the alternating magnetic field generated by the pen and identifies the two-dimensional position information of the pen by supplementarily using the output of one or more of the first magnetic sensors 300 that have detected the magnetic field generated by the permanent magnet.

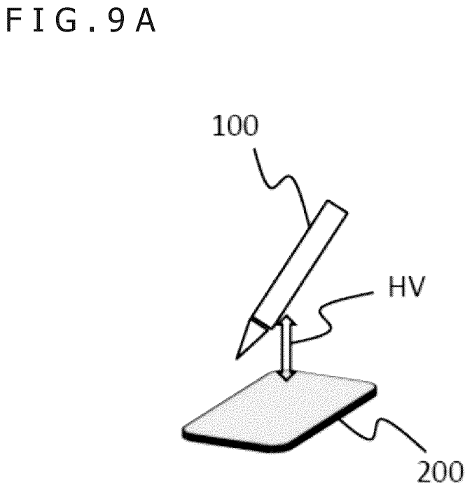

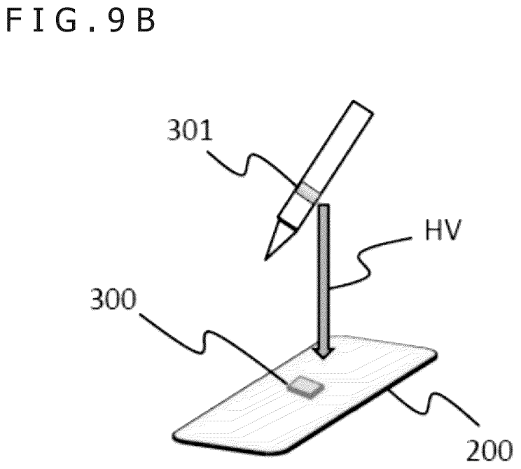

Note that, before description is given on the position detection device 200 according to the present embodiment, the configuration and problems of the position detection device in the related art are described with use of FIGS. 8A through 9B.

As illustrated in FIG. 8A, a position detection device 200E in the related art constitutes part of a tablet and is incorporated in a tablet together with a signal generator, for example.

The position detection device 200E in the related art causes a TX sensor coil group, which constitutes the electromagnetic induction sensor 1, for example, to generate an alternating magnetic field by transmitting a signal generated by the signal generator to a magnetic field through a switch with respect to the TX sensor coil group.

Meanwhile, a pen 100E includes a resonant circuit including a position indication coil (indicated by a reference sign “L” in the figure), a resonant capacitor (indicated by a reference sign “C” in the figure) connected in parallel to the position indication coil, and a variable-capacitance capacitor (indicated by a reference sign “CSW” in the figure) connected in parallel to the resonant capacitor, each of which are illustrated in the figure. The resonant circuit including the variable-capacitance capacitor resonates with a sending-out signal received from the position detection device 200E and performs transfer of energy. Further, the pen 100E transmits the resonance signal detected in the resonant circuit to the position detection device 200E to thereby indicate the position of the pen 100E to the position detection device 200E.

FIG. 8B illustrates a position detection device 200A based on a system different from that of the position detection device 200E in the related art illustrated in FIG. 8A. The position detection device 200E in the related art illustrated in FIG. 8A is a conceptual diagram of the position detection device 200A based on a capacitance system using the mutual capacitance between a TX and an RX.

The position detection device 200A using the capacitance system illustrated in FIG. 8B has conductivity and can detect an object that can cause a change in the mutual capacitance between the TX and the RX. Examples of the object include, as illustrated in FIG. 8B, a finger 110, a conductive pen (stylus) or active capacitance pen (active capacitance stylus) 100A, and the like. Note that, in the following description, these are collectively referred to as the pen 100.

Moreover, the position detection device based on an electromagnetic induction system and the position detection device based on a capacitance system are collectively referred to as the position detection device 200.

FIG. 9A schematically illustrates pen detection when the pen 100 illustrated in FIGS. 8A and 8B is in a hovering HV state. As illustrated in FIGS. 9A and 9B, the position detection device 200 recognizes the approach of the pen 100 at a distance of approximately several centimeters from the position detection device 200 and feeds back the rough position of the pen 100 to a user interface (UI) or to the pen operation detection processing of the sensor system, for example.

The preliminary detection process of the pen 100 in the hovering HV state is an extremely important process in the position detection device 200 that is set based on the premise that writing by the pen 100 will be performed. In the detection process in the position detection device 200 that is set based on the premise that writing by the pen 100 will be performed, distinguishing between a pen tip of the pen 100 and a palm causes a significant issue in many cases. That is, if touch recognition of the palm is performed before the writing by the pen tip of the pen 100, although a user is intending to perform writing by the pen tip of the pen 100, unintended writing may sometimes be performed by the palm, causing the abovementioned issue.

In view of this, distinguishing between the position of the pen tip and the position of the palm is, for example, performed by the preliminary detection process of the pen 100 in the hovering HV state.

In the current position detection device 200E, the recognition height of the pen 100 in the hovering HV state is approximately several centimeters, but the recognition accuracy based on this recognition height is insufficient to distinguish between the position of the pen tip and the position of the palm described above.

Meanwhile, FIG. 9B suggests the use of the magnetic sensors 300 and a permanent magnet 301 for the preliminary detection process of the pen 100 in the hovering HV state. The magnetic sensors 300 are arranged inside, on a rear surface, or the like of the position detection device 200. Moreover, in the case of a position detection device 200 that has a display function, the magnetic sensors 300 are arranged at positions that do not hinder display, such as the inside, the rear surface, or the like of the position detection device 200. The permanent magnet 301 is arranged on the pen 100 side that is to be detected.

This makes it possible to detect hovering HV of the pen 100 at a position that is farther than that in the related art from the position detection device 200, in the static magnetic field of the permanent magnet 301.

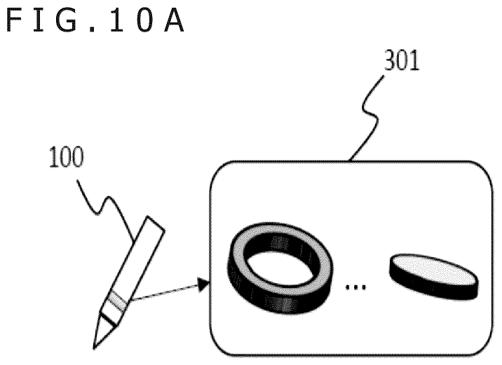

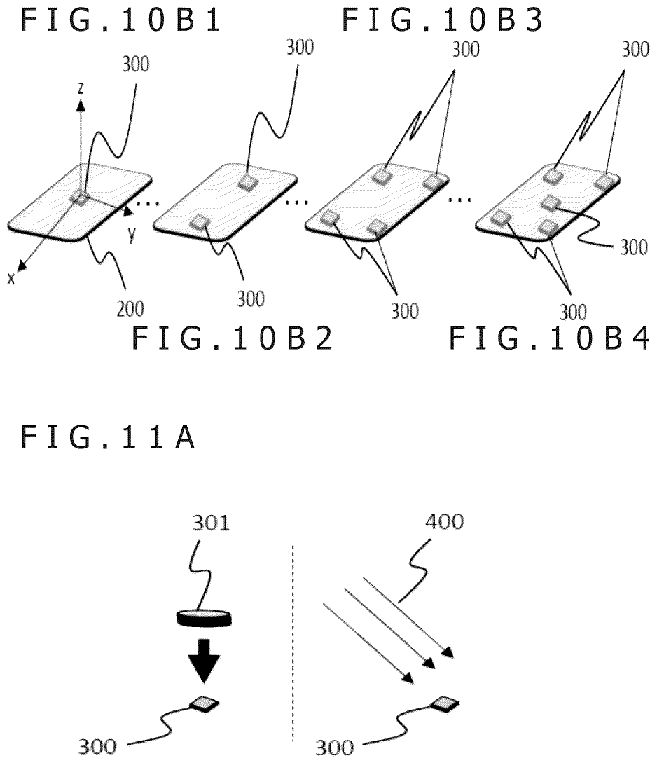

FIG. 10A illustrates an example of a shape of the permanent magnet 301 mounted on the pen 100 that is to be detected. The permanent magnet 301 may have any shape that can be mounted in the pen 100 that is to be detected. Moreover, depending on the shape of the permanent magnet 301 and the strength of the magnetic field, the distance (height) to which the pen 100 that is in the hovering HV state is detectable and the performance required of the magnetic sensors 300, for example, change.

Examples of preferable shapes of the permanent magnet 301 include a shape having a notch, a C shape, a polygonal shape, and a flat shape.

FIGS. 10B1 through 10B4 each illustrate a form of arrangement of the magnetic sensor(s) 300 mounted on the position detection device 200 side.

Typically, the magnetic sensor 300 has detection sensitivity along one through three axes, and the number of magnetic sensors 300 in the present embodiment is at least one. For example, FIG. 10B1 illustrates an example in which one magnetic sensor 300 is mounted at a central portion of the position detection device 200. Further, FIG. 10B2 illustrates an example in which two magnetic sensors 300 are mounted apart from each other in a longitudinal direction of the position detection device 200. FIG. 10B3 illustrates an example in which a total of four magnetic sensors 300 are mounted, one at each of the four corners, in the position detection device 200. FIG. 10B4 illustrates an example in which a total of five magnetic sensors 300 are mounted, one at each of the four corners and the central portion, in the position detection device 200.

As described above, the number of magnetic sensors 300 may be changed as appropriate according to the purpose of use and the required performance such as the detection accuracy.

In detecting the magnetic field of the permanent magnet 301 by use of the magnetic sensors 300, taking into consideration the influence of geomagnetism 400 on earth is an absolute requirement.

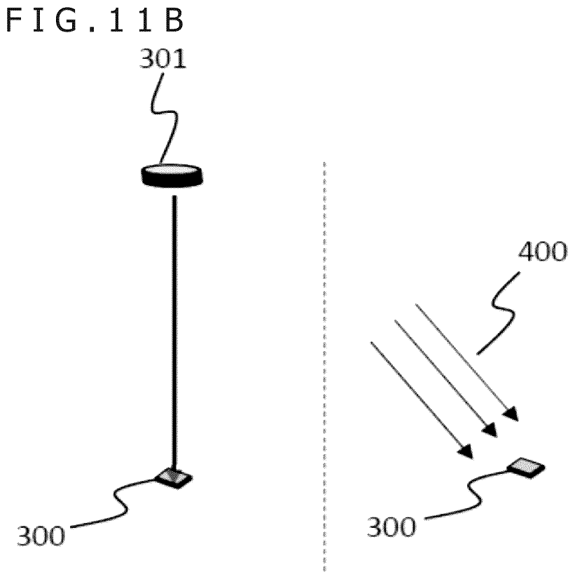

FIGS. 11A and 11B are each a schematic view for describing how the geomagnetism 400 affects detection of the magnetic field of the permanent magnet 301 by the magnetic sensor 300.

As illustrated in FIGS. 11A, in a case where the magnetic sensor 300 and the permanent magnet 301 are at a relatively short distance, the magnetic field of the permanent magnet 301 is detected as a numerical value sufficiently greater than the value of detection of the magnetic field of the geomagnetism 400.

In contrast, as illustrated in FIG. 11B, in a case where the magnetic sensor 300 and the permanent magnet 301 are at a relatively long distance, the magnetic field of the geomagnetism 400 and the magnetic field of the permanent magnet 301 to be detected may have extremely similar numerical values, making it difficult to distinguish one from the other.

Moreover, the abovementioned case may be caused not only by the distance between the magnetic sensor 300 and the permanent magnet 301 but also by the presence of an object that blocks a magnetic field between the magnetic sensor 300 and the permanent magnet 301. Specifically, when it becomes difficult to determine whether the magnetic field is generated by the geomagnetism 400 or the permanent magnet 301 with use of the detected numerical values, it becomes, for example, difficult to determine whether the detection value of geomagnetism 400 has changed due to rotation of the position detection device 200 itself or whether the detection target to which the permanent magnet 301 has been attached has approached, possibly leading to false recognition of the detection target.

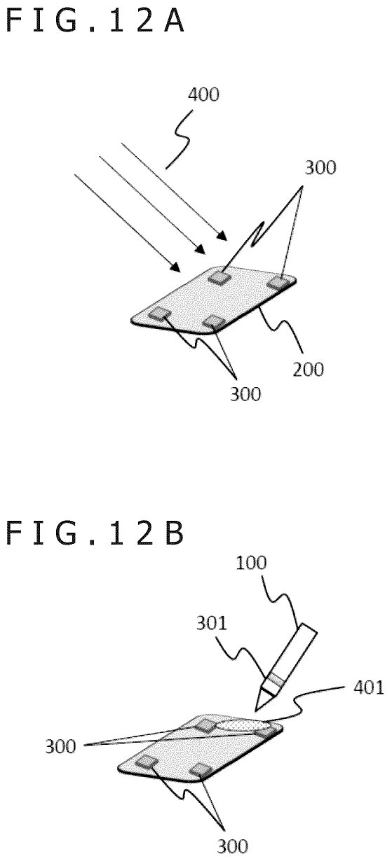

FIGS. 12A and 12B are each diagrams for detecting magnetism of the permanent magnet 301 by the magnetic sensors 300. As illustrated in FIGS. 12A and 12B, arranging a plurality of (two or more) magnetic sensors 300 on the position detection device 200 makes it possible to distinguish between the magnetic field generated by the geomagnetism 400 and a magnetic field 401 generated by the permanent magnet 301. Here, the magnetic sensors 300 are arranged separately from one another by a certain distance (for example, several centimeters or more). As a result, as illustrated in FIG. 12A, the geomagnetism 400 would cause an influence, through its magnetic field, on many magnetic sensors 300 due to being spatially widely distributed.

Meanwhile, as illustrated in FIG. 12B, the influence of the magnetic field 401 generated by the permanent magnet 301 is not distributed in a relatively wide space, so whether the influence is caused by the geomagnetism 400 or the permanent magnet 301 mounted on the pen 100 can easily be determined. This method of determination may include a threshold for the number of magnetic sensors 300 indicating how many magnetic sensors 300 detect the magnetic field and a numerical threshold representing a specific numerical value of the magnetic field for determining that reaction has been made.

Next, FIG. 13 presents a new solution for the problem of detecting the permanent magnet 301 by the magnetic sensor 300. Note that, in the following solution, the magnetic sensor 300 is preferably a magnetic sensor 300 having sensitivity along three axes, that is, the X-axis, the Y-axis, and the Z-axis. In the case of a magnetic sensor 300 having sensitivity along three axes, it is sufficient if the number of magnetic sensors 300 is at least one.

When focus is placed on the numerical values detected by decomposing the magnetic field of the geomagnetism 400 into the X-axis, the Y-axis, and the Z-axis of the magnetic sensor 300, the detection value in each of the X-axis, the Y-axis, and the Z-axis would greatly change depending on the orientation of the magnetic sensor 300 (position detection device 200) relative to the geomagnetism 400. In view of this, the geomagnetism 400 is regarded as a vector, and the following equation 1 is applied to the calculation of a norm 402 (magnitude) of the vector with respect to the detection values in the three-axes of the X-axis, the Y-axis, and the Z-axis.

$$norm 402 ( magnitude of vector ) = \sqrt{\begin{matrix}{( magnitude of vector projected in X direction )}^{2} + \\ {( magnitude of vector projected in Y direction )}^{2} + \\ {( magnitude of vector projected in Z direction )}^{2}\end{matrix}} \qquad [ Equation 1 ]$$

Substituting the detection value in the X-axis of the magnetic sensor 300 for the “magnitude of vector projected in X direction,” the detection value in the Y-axis of the magnetic sensor 300 for the “magnitude of vector projected in Y direction,” and the detection value in the Z-axis of the magnetic sensor 300 for the “magnitude of vector projected in Z direction” in equation 1, the detection values of the magnetic field generated by the geomagnetism 400 can be treated as the norm 402 of the vector.

Since the norm 402 represents the nature of the geomagnetism 400 itself, regardless of the direction in which the position detection device 200 is facing, the norm 402 of the geomagnetism 400 calculated from the detected numerical values of the magnetic field in the X-axis, the Y-axis, and the Z-axis almost does not change.

Specifically, as a result of performing an arithmetic operation using equation 1, the value of the norm 402 of the geomagnetism 400 almost does not change regardless of the direction in which the position detection device 200 is facing, and thus, the influence of the magnetic field 401 of the permanent magnet 301 included in the pen 100 as the detection target that is to newly approach the position detection device 200 would be applied to the norm 402. Hence, monitoring the change in the norm 402 makes it possible to determine whether the permanent magnet 301, as the detection target, has approached, without taking into consideration the influence of the change in the geomagnetism 400 caused by the rotation of the position detection device 200 (see FIG. 13).

Note that, for this determination method, the change in the magnetic field 401 generated by the permanent magnet 301, that is, a threshold for the change in the norm 402, may be defined.

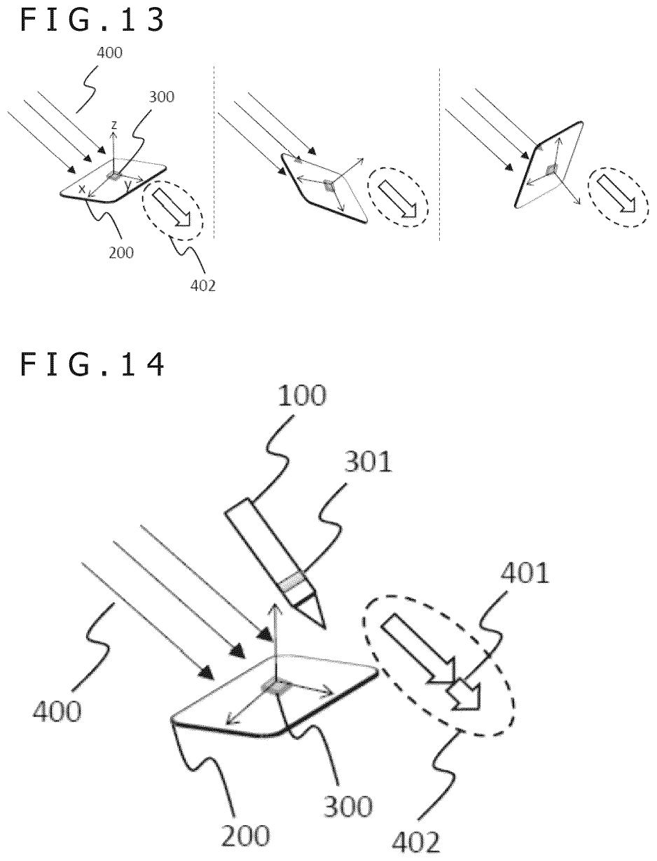

FIG. 14 presents another solution to detect the permanent magnet 301 by the magnetic sensor 300. Here, the magnetic sensor 300 having sensitivity along the three axes of the X-axis, the Y-axis, and the Z-axis is illustrated as an example, but it is sufficient if the magnetic sensor 300 has sensitivity along at least one axis. Further, at least two or more magnetic sensors 300 are required.

Suppose that a result obtained by subtracting the detection values of sensitivity along each of the axes of a magnetic sensor 300A, whose axis sensitivity is different from that of the magnetic sensor 300, from those of the magnetic sensor 300 is referred to as a Diff value.

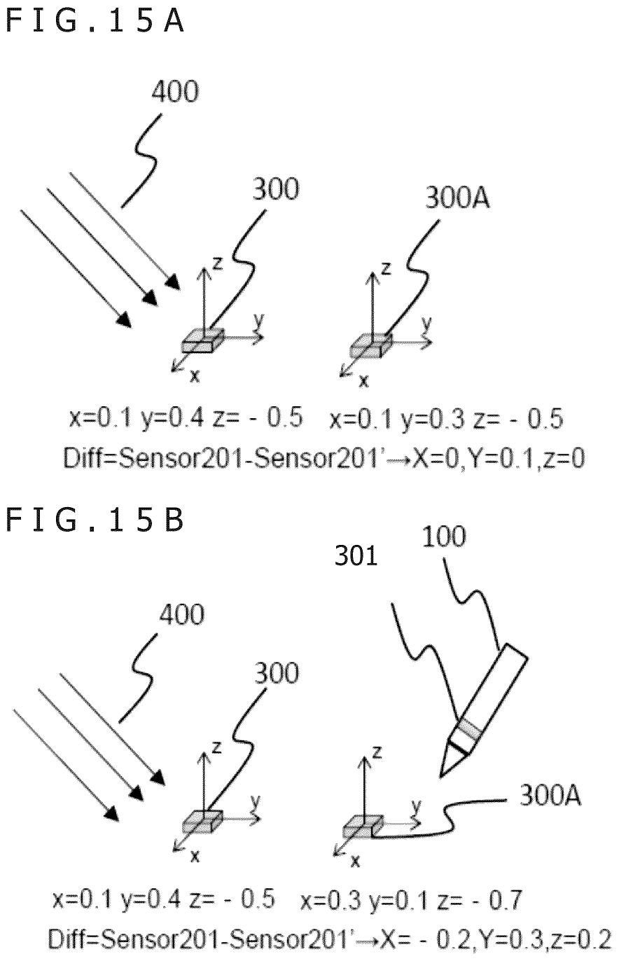

For example, in FIG. 15A, the geomagnetism 400 is spatially widely spread as described above, so that the magnetic sensor 300 and the magnetic sensor 300A would have similar detection values, and the Diff values, which are the result of obtaining the difference between the values, would be close to zero. Specifically, as illustrated in FIG. 15A, in the magnetic sensor 300, the detection values in the axes are detected as X-axis=0.1, Y-axis=0.4, and Z-axis=−0.5, while in the magnetic sensor 300A, X-axis=0.1, Y-axis=0.3, and Z-axis=−0.5; the magnetic sensor 300 and the magnetic sensor 300A have similar detection values, and the Diff values, which are the result of obtaining the difference between the values, are close to zero.

Meanwhile, in FIG. 15B, when the pen 100 including the permanent magnet 301 as the detection target approaches the magnetic sensor 300A, the influence caused by the magnetic field of the geomagnetism 400 becomes almost zero by the calculation of the Diff values, while the influence of the magnetic field on the magnetic sensor 300A caused by the approach of the pen 100 as the detection target remains without being offset by the calculation of the Diff values is calculated as a numerical value having a certain level of absolute value as the Diff value. Specifically, as illustrated in FIG. 15B, in the magnetic sensor 300, the detection values in the axes are detected as X-axis=0.1, Y-axis=0.4, and Z-axis=−0.5, while in the magnetic sensor 300A, the detection values in the axes are detected as X-axis=0.3, Y-axis=0.1, and Z-axis=−0.7; the result of the Diff value operation is 0.2 and calculated as a numerical value having a certain level of absolute value.

That is, this makes it possible to roughly offset the influence of the magnetic field caused by the geomagnetism 400 on the magnetic sensor 300, while leaving the influence of the magnetic field caused by the approaching detection target as the calculation result of the Diff values.

Here, calculating the Diff values is not limited to the method of subtracting the values of the second magnetic sensor 300A from the values of the first magnetic sensor 300, and the values of the first magnetic sensor 300 may be subtracted from the values of the second magnetic sensor 300A. Moreover, when there are three or more magnetic sensors 300, subtraction may be made using detection values of any one of the magnetic sensors 300 as the reference values. Further, Diff values may be an average value of a magnetic sensor 300X that has been selected under desired conditions from three or more magnetic sensors 300.

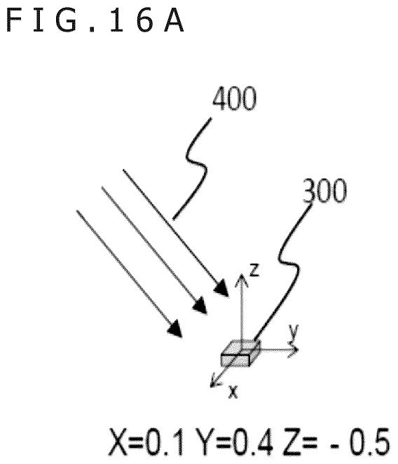

FIGS. 16A and 16B define when an object OB having a magnetic field is present in the vicinity of the magnetic sensor 300 for some kind of reason. In the position detection device 200 according to the present embodiment which allows writing by the pen 100, for example, the permanent magnet 301 or the object OB having a magnetic field, such as a speaker, is assumed to be mounted in an area where an influence may be caused on the magnetic sensor 300.

In this case, assuming that the numerical values as illustrated in FIG. 16A (for example, X=0.1, Y=0.4, and Z=−0.5) are detected due to the magnetic field from the geomagnetism 400, if an object OB that is not a detection target but has a magnetic field is in the vicinity of the magnetic sensor 300 as illustrated in FIG. 16B, the detection values may be numerical values similar to the detection values (for example, X=0.3, Y=0.2, and Z=−0.8) obtained when the pen 100 including the permanent magnet 301 has approached.

In this case, in determining whether the pen 100 has approached by use of a threshold or the like on the program, whether the detected values have been caused by the mere approach of the pen 100 including the permanent magnet 301 or factors including external factors may become difficult to determine. Further, in such a case, the existence of the object OB, which is not a detection target but has a magnetic field, in the vicinity could result in an erroneous determination that the pen 100 is approaching at all times (for example, detecting that X=0.3, Y=−0.2, and Z=−0.6, and determining that the pen 100 is approaching).

Hence, as a measure for handling such a case, acquiring a baseline (reference value) at a desired timing is proposed. This baseline is a detection value of the magnetic sensor 300 stored at each moment.

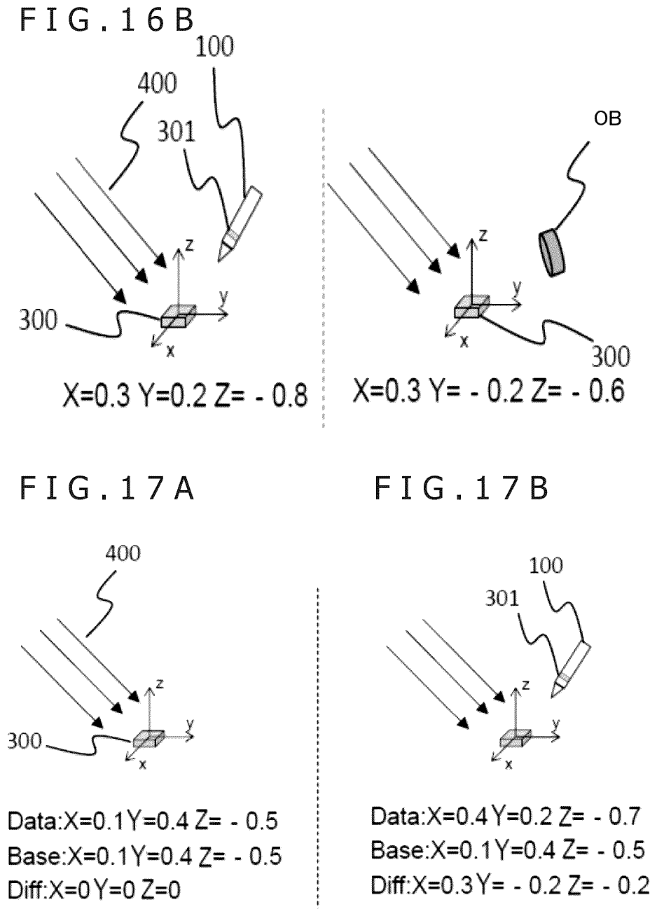

When the stored baseline is subtracted (Diff) from the latest detection values (Data), as illustrated in FIG. 17A, if the geomagnetism 400 alone is present, the magnetic field of the geomagnetism 400 is incorporated as the baseline, so that the influence of the geomagnetism 400 is offset by subtraction (for example, Data: X=0.1, Y=0.4, and Z=−0.5, Base: X=0.1, Y=0.4, and Z=−0.5, Diff: X=0, Y=0, and Z=0). As a result, as illustrated in FIG. 17B, focus is placed on the influence of the magnetic field caused by the approach of the pen 100 having the permanent magnet 301, and the influence can be detected as the Diff values (for example, Data: X=0.4, Y=0.2, and Z=−0.7, Base: X=0.1, Y=0.4, and Z=−0.5, Diff: X=0.3, Y=−0.2, and Z=−0.2).

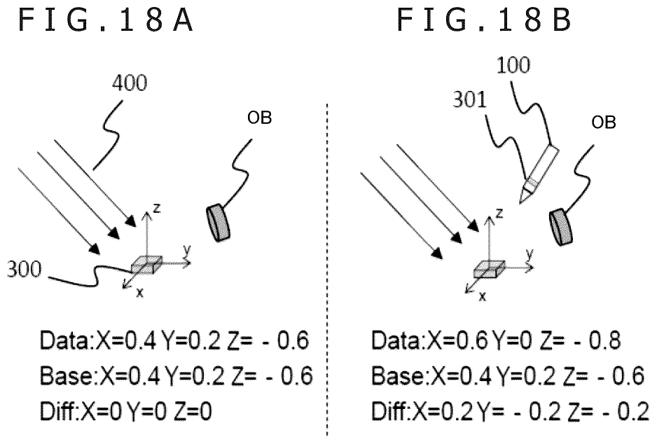

Further, as illustrated in FIG. 18A, also in the case where the object OB, which is not a detection target but has a magnetic field, is present in the vicinity, the influence of the geomagnetism 400 and the influence of the object OB are collectively incorporated as the baselines, and subtraction is performed, so that the influence of the geomagnetism 400 and the influence of the object OB are offset (for example, Data: X=0.4, Y=0.2, and Z=−0.6, Base: X=0.4, Y=0.2, and Z=−0.6, Diff: X=0, Y=0, and Z=0). As a result, as illustrated in FIG. 18B, focus is placed on the influence of the magnetic field caused by the approach of the pen 100 having the permanent magnet 301, and the influence can be detected as the Diff values (for example, Data: X=0.6, Y=0, and Z=−0.8, Base: X=0.4, Y=0.2, and Z=−0.6, Diff: X=0.2, Y=−0.2, and Z=−0.2), preventing false detection of the pen 100.

### Processing in Position Detection Device 200

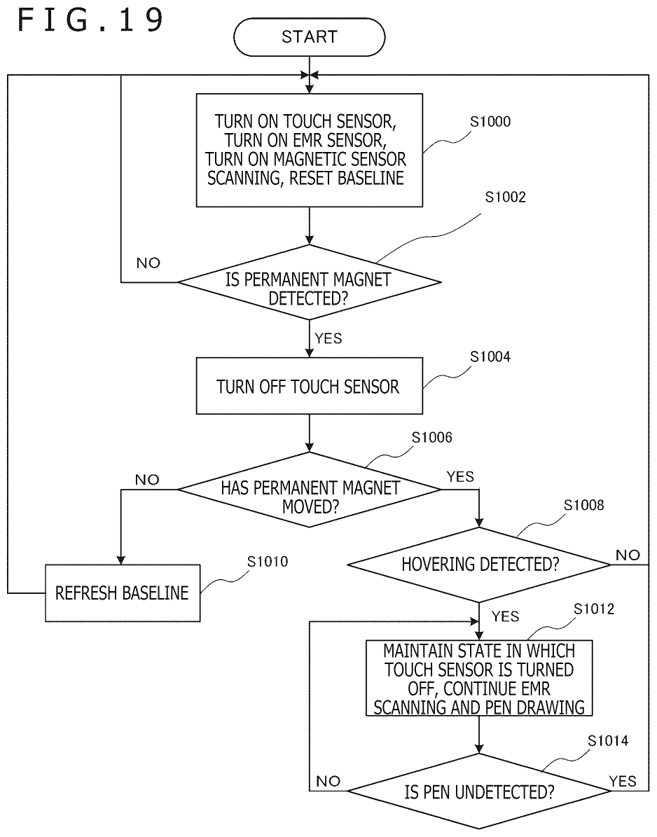

Next, processing in the position detection device 200 according to the present embodiment is described in FIG. 19.

The integrated circuit of the position detection device 200 turns on a touch sensor, an electro-magnetic resonance (EMR) sensor, and the magnetic sensor 300 and resets the baselines and detects magnetism by the magnetic sensor 300 (step S1000). The integrated circuit of the position detection device 200 determines whether the magnetism generated by the permanent magnet 301 has been detected by the magnetic sensor 300 (step S1002).

When determining that the magnetism generated by the permanent magnet 301 has not been detected by the magnetic sensor 300 (“NO” in step S1002), the integrated circuit of the position detection device 200 returns the processing to step S1000, and transitions to a standby mode. On the other hand, when determining that the magnetism generated by the permanent magnet 301 has been detected by the magnetic sensor 300 (“YES” in step S1002), the integrated circuit of the position detection device 200 proceeds to step S1004.

Then, the integrated circuit of the position detection device turns off the touch sensor (step S1004). Next, the integrated circuit of the position detection device 200 determines whether the magnetism detected by the magnetic sensor 300 has moved (whether the permanent magnet 301 has moved) (step S1006).

When determining that the magnetism detected by the magnetic sensor 300 has not moved (the permanent magnet 301 has not moved) (“NO” in step S1006), the integrated circuit of the position detection device 200 causes the processing to proceed to step S1010, refreshes baselines (step S1010), proceeds to step S1000, and transitions to the standby mode. On the other hand, when determining that the magnetism detected by the magnetic sensor 300 has moved (the permanent magnet 301 has moved) (“YES” in step S1006), the integrated circuit of the position detection device 200 proceeds to step S1008 and determines whether the hovering HV state of the pen 100 has been detected (step S1008).

When determining that the hovering HV state of the pen 100 has not been detected (“NO” in step S1008), the integrated circuit of the position detection device 200 returns to step S1000, and transitions to the standby mode. On the other hand, when determining that the hovering HV state of the pen 100 has been detected (“YES” in step S1008), the integrated circuit of the position detection device 200 continues EMR scanning in a state in which scanning by the touch sensor is turned off and continues acquiring information regarding drawing by the pen 100 (step S1012).

Next, when a state in which information regarding the drawing by the pen 100 is unacquirable by the EMR scanning has continued for a predetermined period of time, the integrated circuit of the position detection device 200 proceeds to step S1000 and transitions to the standby mode (step S1014).

Note that, as described above, the processing in the integrated circuit of the position detection device 200 has, as an example, of determining an object OB that is not a detection target but has a magnetic field, a determination step of determining whether the object OB that is not a detection target but has a magnetic field moves as the pen 100 and determining that the object OB is not a detection target when the object OB that is not a detection target but has a magnetic field is static at all times (step S1006).

Moreover, in the abovementioned processing, at the time of detecting the hovering HV state of the pen 100, a palm rejection function of controlling a touch by a palm to be temporarily turned off is realized.

### Action and Effect

As described above, the position detection device 200 according to the present embodiment is a position detection device that detects the position of the pen 100, based on electromagnetic induction action. The pen 100 is provided with the permanent magnet 301 together with the coil that generates an alternating magnetic field. The position detection device 200 further includes the electromagnetic induction sensor 1 in which coil electrodes for detecting the alternating magnetic field generated by the pen 100, based on electromagnetic induction action, are arranged side by side, the plurality of first magnetic sensors 300 provided in the electromagnetic induction sensor 1, and the integrated circuit that executes detects the alternating magnetic field generated by the pen 100 and identifies the two-dimensional position information of the pen 100, by supplementarily using the output of one or more of the first magnetic sensors 300 that have detected the magnetic field generated by the permanent magnet 301.

That is, the pen 100 is provided with the permanent magnet 301 together with the coil that generates an alternating magnetic field, and the integrated circuit detects the alternating magnetic field generated by the pen 100 and identifies the two-dimensional position information of the pen 100, by supplementarily using the output of one or more of the first magnetic sensors 300 that have detected the magnetic field generated by the permanent magnet 301.

Hence, the integrated circuit can capture the movement of the pen 100 from the time when the pen 100 is in the hovering HV state that is a state before the pen 100 comes into contact with the touch surface, and can execute the processing of identifying the two-dimensional position information of the pen 100 when detecting the alternating magnetic field generated by the pen 100.

Accordingly, seeking improved position detection accuracy in the case where the pen is in the hovering state also leads to seeking improved coordinate derivation accuracy in the case where the core body of the pen comes into contact with the touch surface.

Detection of the output of one or more of the first magnetic sensors 300 of the position detection device 200 according to the present embodiment is used for determining whether the pen 100 is present in a predetermined detection space, and the process of identifying the two-dimensional position is executed according to the alternating magnetic field detected by the electromagnetic induction sensor 1. That is, detection of the output of one or more of the first magnetic sensors 300 is used for determining whether the pen 100 is present in the predetermined detection space.

Hence, the integrated circuit can capture the movement of the pen 100 from the time when the pen 100 is in the hovering HV state, that is a state before the pen 100 comes into contact with the touch surface, and can identify the two-dimensional position information of the pen 100 when detecting the alternating magnetic field generated by the pen 100.

Accordingly, seeking improved position detection accuracy in the case where the pen is in the hovering state also leads to seeking improved coordinate derivation accuracy in the case where the core body of the pen comes into contact with the touch surface.

The integrated circuit of the position detection device 200 according to the present embodiment distinguishes between the change in the geomagnetism 400 and the change associated with the approach of the permanent magnet 301 and detecting that the permanent magnet 301 has approached. That is, the integrated circuit distinguishes between the change in the geomagnetism 400 and the change associated with the approach of the permanent magnet 301, excluding the change in the magnetic field caused by the change in the geomagnetism 400, and detects the approach of the permanent magnet 301.

Hence, even under a situation in which an influence is caused by the geomagnetism 400, the integrated circuit can capture the movement of the pen 100 from the time when the pen 100 is in the hovering HV state, that is a state before the pen 100 comes into contact with the touch surface, and can execute the process of identifying the two-dimensional position information of the pen 100 when detecting the alternating magnetic field generated by the pen 100.

Accordingly, even under the situation in which an influence is caused by the geomagnetism 400, seeking improved position detection accuracy in the case where the pen is in the hovering state also leads to seeking improved coordinate derivation accuracy in the case where the core body of the pen comes into contact with the touch surface.

The plurality of first magnetic sensors 300 of the position detection device 200 according to the present embodiment are arranged at predetermined intervals, and the integrated circuit determines how many of the plurality of first magnetic sensors 300 that are arranged at predetermined intervals have detected the change in the predetermined magnetic field. That is, the integrated circuit determines how many of the plurality of the first magnetic sensors 300 arranged at predetermined intervals have detected the change in the predetermined magnetic field.

Here, since the geomagnetism 400 is spatially widely distributed, its magnetic field affects many magnetic sensors 300. Meanwhile, the influence of the magnetic field 401 generated by the permanent magnet 301 is not distributed over a relatively wide space. Hence, determining how many of the plurality of first magnetic sensors 300 arranged at predetermined intervals have detected the change in the predetermined magnetic field makes it possible to determine whether the influence is caused by the geomagnetism 400 or the permanent magnet 301 mounted in the pen 100.

Accordingly, even under the situation in which an influence is caused by the geomagnetism 400, seeking improved position detection accuracy in the case where the pen is in the hovering state also leads to seeking improved coordinate derivation accuracy in the case where the core body of the pen comes into contact with the touch surface.

In the position detection device 200 according to the present embodiment, the predetermined intervals are greater than the intervals of arrangement of the coil electrodes. Here, since the geomagnetism 400 is spatially widely distributed, its magnetic field affects many magnetic sensors 300. Meanwhile, the influence of the magnetic field 401 generated by the permanent magnet 301 is not distributed over a relatively wide space. That is, arranging the plurality of first magnetic sensors 300 at intervals greater than the intervals of arrangement of the coil electrodes makes it possible to minimize the number of first magnetic sensors 300 and also detect the magnetic field generated by the geomagnetism 400.

Accordingly, even under the situation in which an influence is caused by the geomagnetism 400, seeking improved position detection accuracy in the case where the pen is in the hovering state also leads to seeking improved coordinate derivation accuracy in the case where the core body of the pen comes into contact with the touch surface.

The integrated circuit of the position detection device 200 according to the present embodiment regards the geomagnetism 400 as a vector, uses the magnitude of change in the X-axis, the Y-axis, and the Z-axis of the geomagnetism 400 as the norm 402 of the vector, and monitors the change in the norm 402, to thereby distinguish and determine the change associated with the geomagnetism 400 and the change associated with the approach of the permanent magnet 301. That is, focusing on the numerical values detected by decomposing the magnetic field of the geomagnetism 400 into the X-axis, the Y-axis, and the Z-axis of the magnetic sensor 300, the detection value in each of the X-axis, the Y-axis, and the Z-axis greatly varies depending on the direction in which the magnetic sensor 300 is facing relative to the geomagnetism 400.

In view of this, the integrated circuit regards the geomagnetism 400 as a vector, uses the magnitude of change in the X-axis, the Y-axis, and the Z-axis of the geomagnetism 400 as a norm 402, and monitors the change in the norm 402, to thereby distinguish and determine the change associated with the geomagnetism 400 and the change associated with the approach of the permanent magnet 301, so that, regardless of the direction in which the magnetic sensor 300 is facing, the norm 402 of the geomagnetism 400 almost does not change in value, and the influence caused by the magnetic field 401 generated by the permanent magnet 301 included in the pen 100 as the detection target that newly approaches the position detection device 200 is applied to the norm 402.

Hence, monitoring the change in the norm 402 makes it possible to determine the approach of the permanent magnet 301 as the detection target, without taking into consideration the influence of the change in the geomagnetism 400 caused by the rotation of the magnetic sensor 300 (position detection device 200).

Accordingly, even under the situation in which an influence is caused by the geomagnetism 400, seeking improved position detection accuracy in the case where the pen is in the hovering state also leads to seeking improved coordinate derivation accuracy in the case where the core body of the pen comes into contact with the touch surface.

The integrated circuit of the position detection device 200 according to the present embodiment executes distinguishment and determination according to the result of executing the operation processing on the output values from the plurality of first magnetic sensors 300.

That is, the integrated circuit performs, for example, the processing of subtraction for each pair of the detection values in each of the axes of the plurality of magnetic sensors 300 having different sensitivity along each axis. Specifically, since the geomagnetism 400 is spatially widely distributed, the detection values obtained by the plurality of the magnetic sensors 300 have similar values, and the Diff values that are the result of obtaining the difference have values close to zero.

Meanwhile, when the pen 100 including the permanent magnet 301 as the detection target approaches one magnetic sensor 300, the influence of the magnetic field of the geomagnetism 400 would be close to zero by calculation of the Diff values, and the influence of the magnetic field on other magnetic sensors 300 caused by the approach of the pen 100 as the detection target remains without being offset by calculation of the Diff values and is calculated as a numerical value having a certain level of absolute value as the Diff value.

This makes it possible to roughly offset the influence of the magnetic field on the magnetic sensors 300 by the geomagnetism 400, while leaving the influence of the magnetic field caused by the approaching detection target as the result of calculation of the Diff values.

Accordingly, even under the situation in which an influence is caused by the geomagnetism 400, seeking improved position detection accuracy in the case where the pen is in the hovering state also leads to seeking improved coordinate derivation accuracy in the case where the core body of the pen comes into contact with the touch surface.

The integrated circuit of the position detection device 200 according to the present embodiment includes the storage that stores detection values that have been detected at a certain timing by the plurality of first magnetic sensors 300, and the integrated circuit executes operation processing on, among the detection values stored in the storage, at least the detection value(s) detected at a certain timing by one first magnetic sensor 300 and the detection value(s) most recently detected by the one first magnetic sensor 300, and thereby executes the distinguishment and determination.

That is, the case where an influence is caused by the magnetic field of the geomagnetism 400 and the case where the object OB that is not a detection target but has a magnetic field is in the vicinity of the magnetic sensor 300 may have detection values similar to those in the case where the pen 100 including the permanent magnet 301 is approaching. Hence, the case where the object OB that is not a detection target but has a magnetic field is in the vicinity could be erroneously determined that the pen 100 is approaching at all times.

In view of this, the baselines (reference values) are acquired at a desired timing. These baselines are detection values of the magnetic sensors 300 stored at each moment.

When the stored baselines are subtracted from the latest detection values, if the geomagnetism 400 alone is present, incorporating the magnetic field of the geomagnetism 400 as the baselines makes it possible to offset the influence of the geomagnetism 400 by subtraction and to focus on and detect the influence of the magnetic field caused by the approach of the pen 100 including the permanent magnet 301 as the detection value.

Accordingly, even in a case where an influence is caused by the geomagnetism 400 or under a situation in which an object OB having a magnetic field is in the vicinity of the magnetic sensor 300, seeking improved position detection accuracy in the case where the pen is in the hovering state also leads to seeking improved coordinate derivation accuracy in the case where the core body of the pen comes into contact with the touch surface.

The integrated circuit of the position detection device 200 according to the present embodiment executes the distinguishment and determination, based on the variation in the output values of the first magnetic sensors 300. That is, acquiring the baselines (reference values) at a desired timing and performing subtracting processing with the latest detection values make it possible to determine the variation in the output values of the first magnetic sensor 300.

If the variation in the output values of the first magnetic sensors 300 can be obtained, the influence of the magnetic field caused by the approach of the pen 100 including the permanent magnet 301 can be detected as the detection values. Hence, even in a case where an influence is caused by the geomagnetism 400 or under a situation in which an object OB having a magnetic field is in the vicinity of the magnetic sensor 300, seeking improved position detection accuracy in the case where the pen is in the hovering state also leads to seeking improved coordinate derivation accuracy in the case where the core body of the pen comes into contact with the touch surface.

The integrated circuit of the position detection device 200 according to the present embodiment rewrites, when there is no predetermined variation in the output values of the first magnetic sensors 300, the detection values stored in the storage to subsequently obtained detection values. That is, when there is no predetermined variation in the output values of the first magnetic sensors 300, the magnetic field can be considered to have no specific disturbance, so that rewriting the numerical values stored in the storage to detection values in this case makes it possible to recognize any specific disturbance that may occur in the subsequent processing.

Hence, as a result of executing such processing, seeking improved position detection accuracy in the case where the pen is in the hovering state also leads to seeking improved coordinate derivation accuracy in the case where the core body of the pen comes into contact with the touch surface.

### Third Embodiment

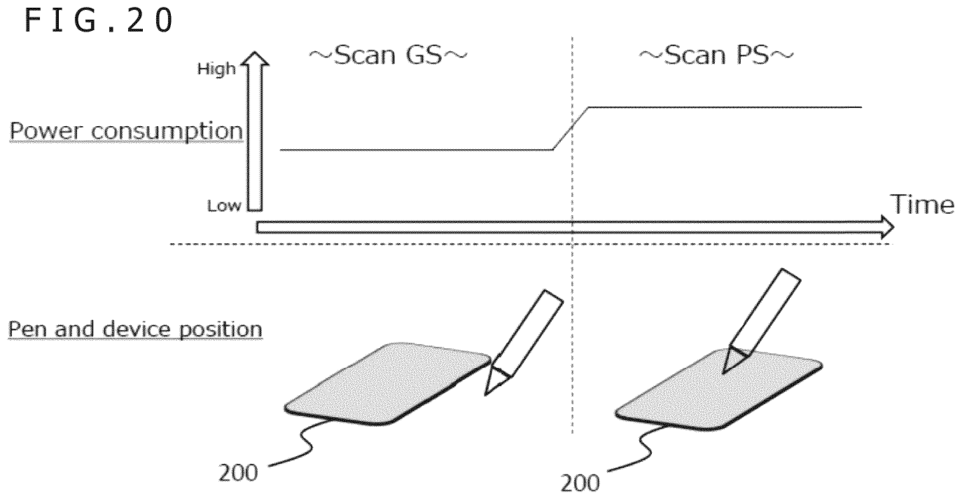

Next, a position detection device 200A according to a third embodiment of the present disclosure is described with use of FIGS. 20 through 22.

### Position Detection Device 200A

The position detection device 200A according to the present embodiment includes the pen 100 provided with the permanent magnet 301 together with the coil that generates an alternating magnetic field, the electromagnetic induction sensor 1 in which coil electrodes for detecting the alternating magnetic field generated by the pen 100, based on electromagnetic induction action, are arranged side by side, the plurality of first magnetic sensors 300 provided in the electromagnetic induction sensor 1, and the integrated circuit that detects the alternating magnetic field generated by the pen 100 and identifies the two-dimensional position information of the pen 100 by supplementarily using the output of one or more of the first magnetic sensors 300 that have detected the magnetic field generated by the permanent magnet 301.

The integrated circuit of the position detection device 200A according to the present embodiment particularly changes the scan mode of the pen 100 by the electromagnetic induction sensor 1, according to the mode of detecting magnetism by the first magnetic sensors 300. More specifically, when magnetism is detected by the first magnetic sensors 300, the integrated circuit turns on the global scan mode.

Moreover, in a case where a state in which the position information of the pen 100 is unacquirable continues for a predetermined period of time even when the global scan mode is turned on, the integrated circuit executes control of turning off the global scanning. Further, the position detection device 200A according to the present embodiment includes a notifying circuit that issues a message to the user. When the notifying circuit has issued, to a user, a message for causing the user to rotate a main body of the position detection device 200A and the user rotates the main body of the position detection device 200A, the integrated circuit changes the scan mode according to the amount of change in the output detection values of the first magnetic sensors 300.

At the time of detecting the hovering state for detecting the approach of the pen 100 in the air, the distance between the sensor and the pen 100 is greater than that at the time of writing. Hence, in a sensor system for detecting the pen 100 (for example, an EMR sensor system and a capacitance touch system), the sensor performs scanning GS (hereinafter referred to as global scanning) for searching for the pen 100 by consuming a certain amount of power.

Global scanning GS is performed even before the pen 100 approaches the position detection device 200A. If the pen 100 is at a position separated from the top surface of the position detection device 200A and the user has no intention to write, the global scanning GS for searching for the pen 100 is nothing but a waste of power. Hence, replacing the global scanning GS for searching for the pen 100 with scanning MS by the magnetic sensors 300 and the determination on the approach of the detection target using the detection values can substantially reduce power consumption. Specifically, in a case where the permanent magnet 301 is not detected by the global scanning GS, turning off the global scanning GS or controlling the global scanning GS to an extremely low rate makes it possible to perform the abovementioned replacement.

However, the abovementioned control is effective for the pen 100 including the permanent magnet 301, but is not applicable to a pen having an ordinary specification with no permanent magnet 301. That is, for example, when a pen having an ordinary specification with no permanent magnet 301 approaches the position detection device 200A at the time of turning off the global scanning GS or controlling the global scanning GS to a low rate, there may occur a situation in which this pen having an ordinary specification with no permanent magnet 301 is not recognized or is recognized after a long period of time has elapsed.

In view of this, in order to switch the control mode to the mode for writing for a pen having an ordinary specification with no permanent magnet 301, for example, prompting the user to perform a gesture motion or the like with respect to the position detection device 200A using the detection values of the magnetic sensors 300 makes it possible to execute mode control without the need for an additional component other than the first magnetic sensors 300, allowing compatibility between a pen having an ordinary specification with no permanent magnet 301 and the pen 100 including the permanent magnet 301 to be maintained.

Here, a gesture motion with respect to the position detection device 200A using the first magnetic sensors 300 is an operation of recognizing a swift rotation operation, movement other than a rotation, or the like of the position detection device 200A as a characteristic change in the detection values, by utilizing the temporal change in the positional relation between the geomagnetism 400 and the sensor that is caused by the rotation of the position detection device 200A, and changing the control mode by using such a change as a trigger.

Note that scanning PS is defined as an operation for scanning the pen 100 on the surface of the position detection device 200A. That is, the integrated circuit of the position detection device 200A according to the present embodiment turns on the global scanning GS for a pen having an ordinary specification with no permanent magnet 301 when the pen is outside the surface of the position detection device 200A, as illustrated in FIG. 20.

Moreover, the integrated circuit of the position detection device 200A according to the present embodiment turns on the scanning PS for a pen having an ordinary specification with no permanent magnet 301 when the pen is on the surface of the position detection device 200A, as illustrated in FIG. 20.

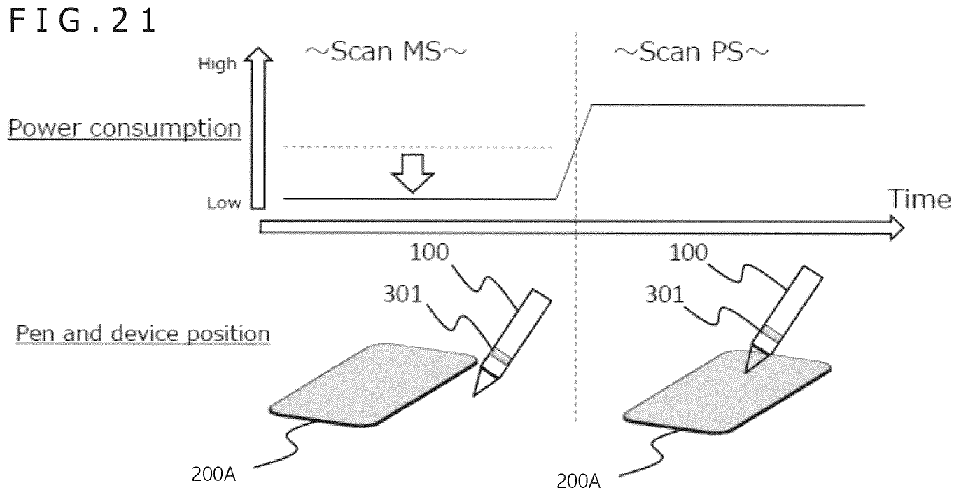

Meanwhile, the integrated circuit of the position detection device 200A according to the present embodiment turns off the global scanning GS for the pen 100, including the permanent magnet 301, when the pen 100 is outside the surface of the position detection device 200A and magnetism can be detected by the magnetic sensors 300, and replaces the global scanning GS with the scanning MS and the determination on the approach of the detection target using the detection values, to thereby reduce power consumption, as illustrated in FIG. 21.

Moreover, the integrated circuit of the position detection device 200A according to the present embodiment performs control, for the pen 100 including the permanent magnet 301, of turning on the scanning PS when the pen 100 is on the surface of the position detection device 200, as illustrated in FIG. 21.

### Processing in Position Detection Device 200A

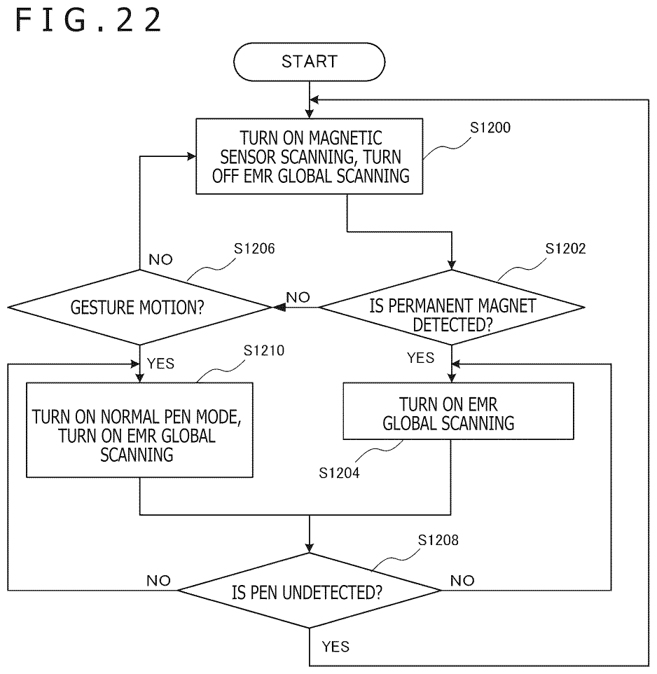

Next, processing in the position detection device 200A according to the present embodiment is described with use of FIG. 22. The integrated circuit of the position detection device 200A turns off EMR global scanning GS and turns on scanning by the magnetic sensors 300, to detect magnetism (step S1200). The integrated circuit of the position detection device 200A determines whether magnetism generated by the permanent magnet 301 is detected by the magnetic sensors 300 (step S1202).

Next, when determining that the magnetism generated by the permanent magnet 301 is detected by the magnetic sensors 300 (“YES” in step S1202), the integrated circuit of the position detection device 200A executes control of turning on the EMR global scanning GS (step S1204). Subsequently, the integrated circuit of the position detection device 200A determines whether the pen 100 is undetected (step S1208). Specifically, for example, the integrated circuit of the position detection device 200A determines whether the pen 100 is undetected, according to whether a state in which information regarding drawing by the pen 100 is unacquirable by the global scanning GS mode has continued for a predetermined period of time.

When determining that the pen 100 is undetected (“YES” in step S1208), the integrated circuit of the position detection device 200A proceeds to step S1200. On the other hand, when determining that the pen 100 is detected (“NO” in step S1208), the integrated circuit of the position detection device 200A proceeds to step S1204.

When determining that the magnetism generated by the permanent magnet 301 has not been detected by the magnetic sensors 300 (“NO” in step S1202), the integrated circuit of the position detection device 200A determines whether a gesture motion such as a rotation of the position detection device 200A has been performed (step S1206). When determining that a gesture motion such as a rotation of the position detection device 200A has not been detected (“NO” in step S1206), the integrated circuit of the position detection device 200A returns the processing to step S1200.

On the other hand, when determining that a gesture motion such as a rotation of the position detection device 200A has been detected (“YES” in step S1206), the integrated circuit of the position detection device 200A sets the control mode to a normal mode that is applied to a pen having an ordinary specification with no permanent magnet 301 and turning on the global scanning GS mode (step S1210).

The integrated circuit of the position detection device 200A then determines whether the pen 100 is undetected (step S1208). Specifically, for example, the integrated circuit of the position detection device 200A determines whether the pen 100 is undetected, according to whether a state in which information regarding drawing by the pen 100 is unacquirable by the global scanning GS mode has continued for a predetermined period of time.

When determining that the pen 100 is undetected (“YES” in step S1208), the integrated circuit of the position detection device 200A proceeds to step S1200.

On the other hand, when determining that the pen 100 in detected (“NO” in step S1208), the integrated circuit of the position detection device 200A proceeds to step S1210.

### Action and Effect

As described above, the integrated circuit of the position detection device 200A according to the present embodiment executes control of turning on the global scan mode, when the magnetism generated by the permanent magnet 301 is detected by the first magnetic sensors 300.

That is, when the magnetism generated by the permanent magnet 301 is detected by the first magnetic sensors 300, the pen is the pen 100 including the permanent magnet 301, so that the integrated circuit executes control of turning on the global scan mode by using the detection of the magnetism as a trigger.

Conversely, when the magnetism generated by the permanent magnet 301 is not detected by the first magnetic sensors 300, the pen is a pen having an ordinary specification with no permanent magnet 301, so that the integrated circuit executes control of continuing the global scan mode until the scan mode transitions to the scanning PS.

Hence, when the pen is the pen 100 including the permanent magnet 301, the length of time of using the global scan mode, which consumes great power, can be shortened, making it possible to reduce power consumption.

The integrated circuit of the position detection device 200A according to the present embodiment executes control of turning off the global scanning GS in a case where a state in which position information of the pen is unacquirable has continued for a predetermined period of time even when the global scan mode is turned on.

That is, in a case where a state in which position information of the pen 100 is unacquirable has continued for a predetermined period of time even when the global scan mode is turned on, the integrated circuit can determine that the user has no intention to perform writing, and hence, in such a case, turns off the global scanning GS that consumes great power.

Accordingly, when the pen is the pen 100 including the permanent magnet 301, as a result of the global scan mode which had been turned on being turned off, the length of time of using the global scan mode, which consumes great power, can further be shortened, making it possible to increase the effect of reducing power consumption.

The integrated circuit of the position detection device 200A according to the present embodiment includes a notifying circuit that issues a message to the user, and changes the scan mode according to the amount of change in the output detection values of the first magnetic sensors 300 when the notifying circuit issues a message for rotating the main body of the position detection device 200A to the user and causes the user to perform the operation of rotating the main body of the position detection device 200A.

That is, by issuing a message for rotating the main body of the position detection device 200A to the user and prompting the user to perform the operation of rotating the main body of the position detection device 200A, the output detection values of the first magnetic sensors 300 are varied.

Utilizing the temporal change in the relation between the geomagnetism 400 and the sensor caused by the rotation of the position detection device 200A makes it possible to determine whether the pen is the pen 100 including the permanent magnet 301 or a pen having an ordinary specification with no permanent magnet 301.

Accordingly, accurately and easily determining the type of the pen can optimize the amount of power consumption.

### Fourth Embodiment

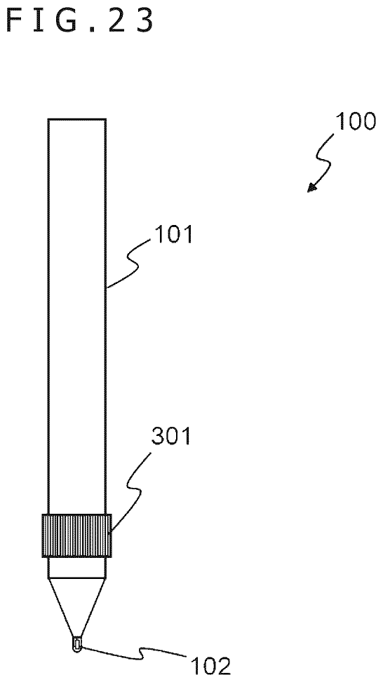

Next, a pen 100 according to a fourth embodiment of the present disclosure is described with use of FIGS. 23 through 28.

### Pen 100

The pen 100 according to the present embodiment includes the permanent magnet 301 in the vicinity of a core body 102 that is exposed outside from a tubular casing 101 made of resin, for example, as illustrated in FIG. 23.

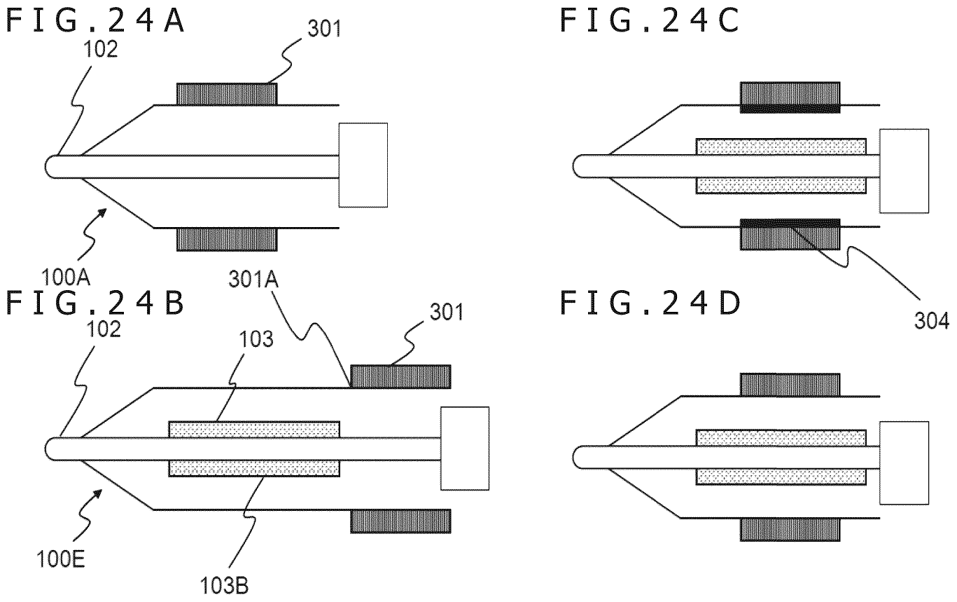

FIG. 24A is a cross sectional view of an active capacitance pen 100A assumed to be used with the position detection device 200A using a capacitive induction system. In FIG. 24A, the permanent magnet 301 is provided in the vicinity of the core body 102 exposed outside from the tubular casing 101 that is made of resin and that is included in the active capacitance pen 100A. As illustrated in FIG. 24A, the active capacitance pen 100A has a configuration similar to that of an active capacitance pen based on a known capacitive induction system, except for including the permanent magnet 301 in the vicinity of the core body 102. In FIG. 24A, the permanent magnet 301 is not limited to having a cylindrical shape, and may instead have a shape including a notch, a C shape, a polygonal shape, or a flat shape.

Moreover, the permanent magnet 301 may be provided in half the circumference or part of the circumference of the active capacitance pen 100A, instead of being provided in the whole circumference of the active capacitance pen 100. Further, when being provided in the vicinity of the core body 102 that is exposed outside from the tubular casing 101 made of resin, the permanent magnet 301 preferably has, for example, a cylindrical shape, a shape having a notch, or a C shape, and when being provided inside the tubular casing 101 made of resin, the permanent magnet 301 preferably has, for example, a polygonal shape or a flat shape.

FIGS. 24B, 24C, and 24D are each a cross sectional view of the pen 100E assumed to be used with a position detection device using the electromagnetic induction system. The pen 100E illustrated in FIG. 24B has a configuration similar to that of the pen based on a known electromagnetic induction system, except for including the permanent magnet 301 in the vicinity of the core body 102. The pen 100E illustrated in FIG. 24B includes an LC resonant circuit including a magnetic core 103.

Regarding the pen 100E illustrated in FIG. 24B, the position detection device 10, 200, or 200A receives a pen signal that is a response alternating magnetic field generated by the LC resonant circuit and detects the position or the pen pressure of the pen 100E. In the pen 100E illustrated in FIG. 24B, in order to avoid interference with the magnetic characteristics of the magnetic core 103 by the permanent magnet 301, an end portion 301A of the permanent magnet 301 is disposed to be rearward of an end portion 103B of the magnetic core 103 in an axial direction of the core body 102. The permanent magnet 301 is not limited to having a cylindrical shape, and may instead have a shape having a notch or a C shape.

Moreover, the permanent magnet 301 may be provided in half the circumference or part of the circumference of the pen 100E illustrated in FIG. 24B, instead of being provided in the whole circumference of the pen 100E.

The pen 100E illustrated in FIG. 24C has a configuration similar to that of a pen based on a known electromagnetic induction system, except for including the permanent magnet 301 in the vicinity of the core body 102 and including a magnetism shielding member 304 in the permanent magnet 301 facing the magnetic core 103.

In the pen 100E illustrated in FIG. 24C, the permanent magnet 301 is provided, via the magnetism shielding member 304, in the vicinity of the core body 102 exposed outside from the tubular casing 101 that is made of resin and that is included in the pen 100E.

It is sufficient if the magnetism shielding member 304 is provided at a position where interference with the magnetic characteristics of the magnetic core 103 can be avoided, for example, on an inner wall or an outer wall of the casing 101, instead of being provided in the permanent magnet 301.

The permanent magnet 301 is not limited to having a cylindrical shape, and may instead have a shape having a notch, a C shape, a polygonal shape, or a flat shape. Moreover, the permanent magnet 301 may be provided in half the circumference or part of the circumference of the pen 100E illustrated in FIG. 24C, instead of being provided in the whole circumference of the pen 100E.

The pen 100E illustrated in FIG. 24D has a configuration similar to that of a pen based on a known electromagnetic induction system, except for including the permanent magnet 301 in the vicinity of the core body 102. As described above, in the pen 100E illustrated in FIG. 24D, the permanent magnet 301 being arranged in the vicinity of the magnetic core 103 causes interference with the magnetic characteristics of the magnetic core 103 and a change in the inductance value.

Hence, even when the resonance frequency of the resonant circuit is selected to be equal to the frequency of the alternating current signal transmitted from the position detection device 10, 200, or 200A, the effective resonance frequency changes in association with the amount of change in the inductance value. Accordingly, it is sufficient if the resonance frequency of the resonant circuit is selected to be a value different from the frequency of the alternating current signal transmitted from the position detection device 10, 200, or 200A, by taking into consideration in advance the amount of change in the inductance value of the magnetic core 103 caused by the permanent magnet 301.

Moreover, the permanent magnet 301 is not limited to having a cylindrical shape, and may instead have a shape having a notch or a C shape. Further, the permanent magnet 301 may be provided in half the circumference or part of the circumference of the pen 100E illustrated in FIG. 24D, instead of being provided in the whole circumference of the pen 100E.

As described above, according to the active capacitance pens 100A and 100E illustrated in FIGS. 23 through 24D, providing the permanent magnet 301 enables the position detection device 10, 200, or 200A using the capacitive induction system or the electromagnetic induction system to detect the coordinate position indicated by the active capacitance pen 100A or 100E at the same level of accuracy as that in the related art.

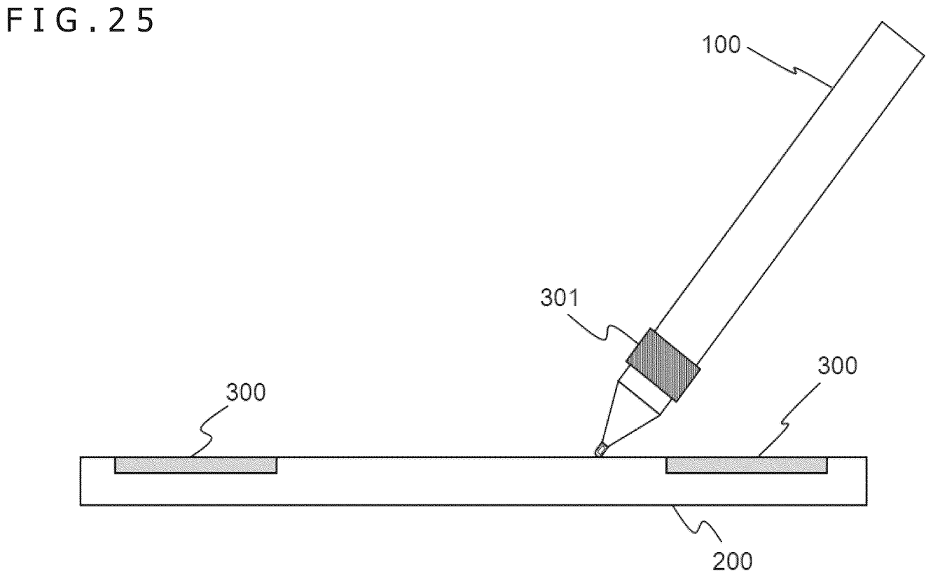

FIG. 25 illustrates a case where the pen 100 including the permanent magnet 301 is tilted relative to the position detection device 10, 200, or 200A including one or more magnetic sensors 300. Note that the following description is given by taking as an example a case in which the permanent magnet 301 has anisotropy and the magnetic sensor 300 is a three-axis magnetic sensor, for example.

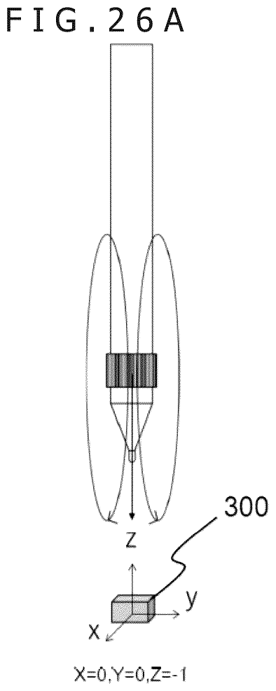

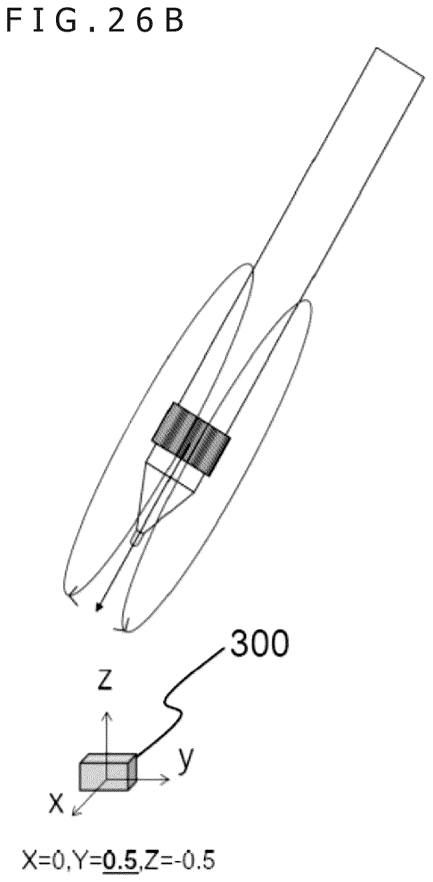

FIGS. 26A and 26B illustrate examples of numerical values detected by decomposing the magnetic field of the pen 100 including the permanent magnet 301 into the X-axis, the Y-axis, and the Z-axis of the magnetic sensor 300. Note that, in FIGS. 26A and 26B, the magnetic sensor 300 is illustrated as being a three-axis magnetic sensor.

FIG. 26A illustrates examples of numerical values that are detected by decomposing the magnetic field of the pen 100 into the X-axis, the Y-axis, and the Z-axis of the magnetic sensor 300, in a case where the pen 100 is vertical to the magnetic sensor 300. In the case of FIG. 26A, the numerical values obtained by decomposing the magnetic field into each axis are as follows: X=0, Y=0, and Z=−1.

FIG. 26B illustrates examples of numerical values that are detected by decomposing the magnetic field of the pen 100 into the X-axis, the Y-axis, and the Z-axis of the magnetic sensor 300 in a case where the pen 100 is tilted at a desired angle by the user as the pen 100 illustrated in FIG. 25. In the case of FIG. 26B, the numerical values detected by decomposing the magnetic field into each axis are as follows: X=0, Y=0.5, and Z=−0.5.

Here, in FIG. 26A, the value indicated by the Y-axis is “0,” but in FIG. 26B, the value indicated by the Y-axis has changed to “0.5,” so that the tilt information of the pen 100 can be detected by the magnetic sensor 300. The magnetic sensor 300 may, for example, be provided in the vicinity of an outer periphery of the drawing area of the position detection device 200. This makes it possible to detect the pen 100 that is present outside the drawing area of the position detection device 200 before the pen 100 enters the drawing area.

Moreover, since the magnetic sensor 300 detects the hovering HV state of the pen 100 in the drawing area, the magnetic sensor 300 may have sensitivity along one or more axes. In a case where a plurality of magnetic sensors 300 are to be arranged in the position detection device 10, 200, or 200A, the magnetic sensors 300 are provided separately from one another by a predetermined distance (for example, one or more centimeters). This allows the magnetic sensors 300 to distinguish the magnetic field 401 of the permanent magnet 301 that is distributed in a narrower range than the geomagnetism 400 from the magnetic field generated by the geomagnetism 400.

Moreover, the permanent magnet 301 is not limited to having a cylindrical shape, and may instead have a shape including a notch, a C shape, a polygonal shape, or a flat shape. Further, the permanent magnet 301 may be provided in half the circumference or part of the circumference of the pen 100, instead of being provided in the whole circumference of the pen 100.

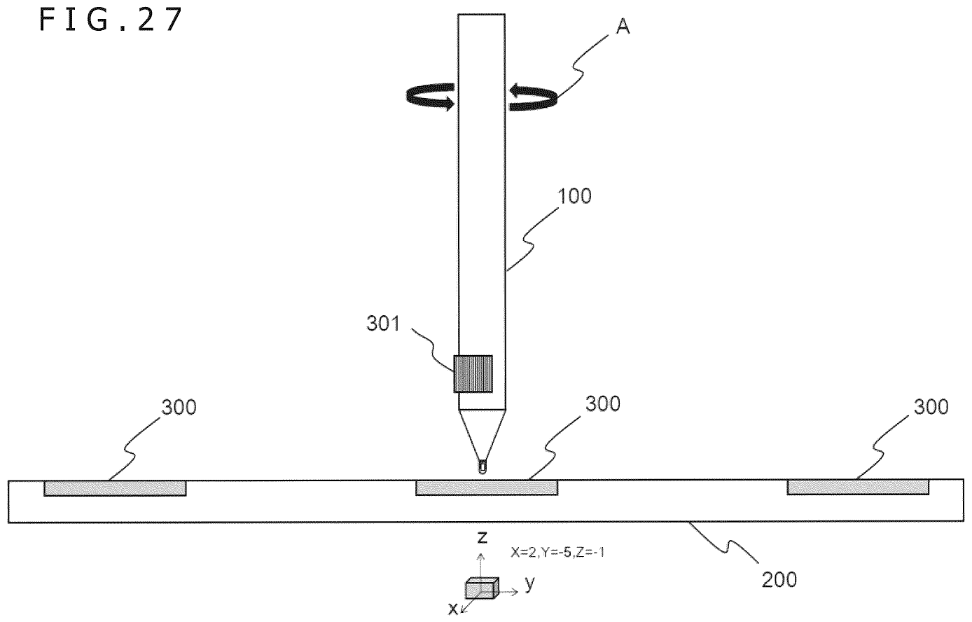

FIG. 27 illustrates examples of numerical values that are detected by decomposing the magnetic field in the case of rotating the pen 100 in an A direction (counterclockwise) into the X-axis, the Y-axis, and the Z-axis of the magnetic sensor 300. In the case of FIG. 27, the numerical values detected by decomposing the magnetic field of the pen 100 into each axis are as follows: X=2, Y=−5, and Z=−1.

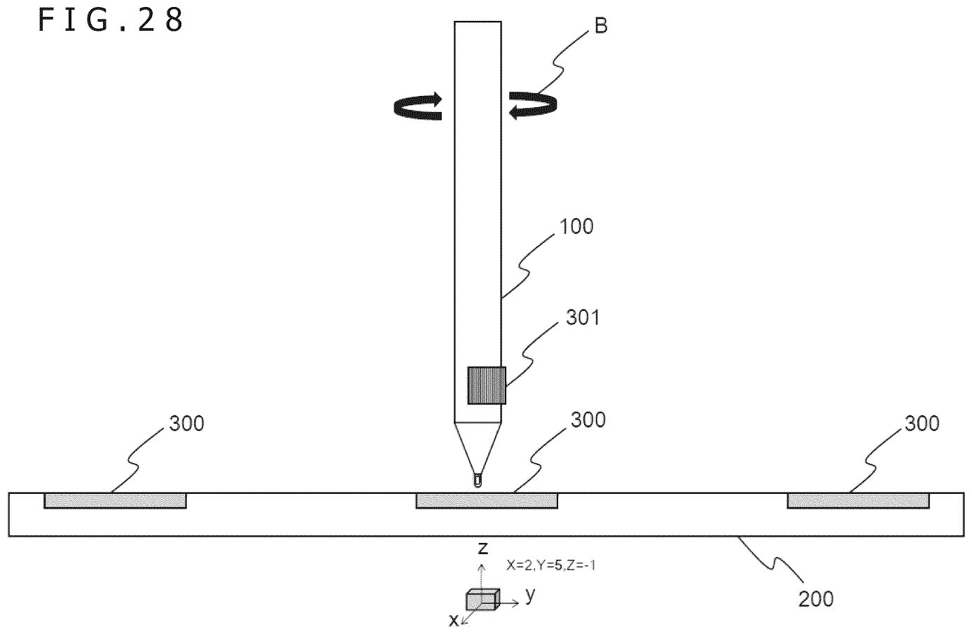

FIG. 28 illustrates examples of numerical values that are detected by decomposing the magnetic field in the case of rotating the pen 100 in a B direction (clockwise) into the X-axis, the Y-axis, and the Z-axis of the magnetic sensor 300. In the case of FIG. 28, the numerical values detected by decomposing the magnetic field into each axis are as follows: X=2, Y=5, and Z=−1.

Here, in FIG. 27, the value indicated by the Y-axis is “−5,” while in FIG. 28, the value indicated by the Y-axis has changed to “5,” so that the rotation information of the pen 100 can be detected by the magnetic sensor 300.

Moreover, since the magnetic sensor 300 detects the hovering HV state of the pen 100 in the drawing area, the magnetic sensor 300 may have sensitivity along one or more axes. In the case of providing a plurality of magnetic sensors 300 in the position detection device 10, 200, or 200A, the magnetic sensors 300 are provided separately from one another by a predetermined distance (for example, one or more centimeters). This allows the magnetic sensors 300 to distinguish the magnetic field 401 of the permanent magnet 301 that is distributed in a narrower range than the geomagnetism 400 from the magnetic field generated by the geomagnetism 400.

Moreover, the permanent magnet 301 is not limited to having a cylindrical shape, and may instead have a shape including a notch, a C shape, a polygonal shape, or a flat shape. Further, the permanent magnet 301 may be provided in half the circumference or part of the circumference of the pen 100, instead of being provided in the whole circumference of the pen 100.

### Action and Effect

As described above, in the pen 100 according to the present embodiment, the permanent magnet 301 is arranged at a position rearwardly separated from the coil in the axial direction. That is, the permanent magnet 301 is provided at a distance from the coil on the rear side thereof in the axial direction. This can restrain the magnetic field generated by the permanent magnet 301 from having a magnetic influence on the coil.

Accordingly, the position detection accuracy in the case where the pen is in the hovering state can be improved at low cost.

In the pen 100 according to the present embodiment, the permanent magnet 301 is arranged inside the casing 101 of the pen 100 and rearward of the coil in the axial direction. That is, the permanent magnet 301 is provided inside the casing 101 of the pen 100 and at a distance from the coil on the rear side thereof in the axial direction. Hence, the magnetic field generated by the permanent magnet 301 can be restrained from having a magnetic influence on the coil.

Accordingly, the position detection accuracy in the case where the pen is in the hovering state can be improved at low cost.

In the pen 100 according to the present embodiment, the magnetism shielding member 304 is arranged between the coil and the permanent magnet 301. That is, providing the magnetism shielding member 304 between the coil and the permanent magnet 301 makes it possible to avoid interference with the magnetic characteristics of the magnetic core 103 by the permanent magnet 301.

Accordingly, the position detection accuracy in the case where the pen is in the hovering state can be improved.

The pen 100 according to the present embodiment includes a resonant circuit, and the resonance frequency of the resonant circuit is different from the resonance frequency in the case of including no magnet. That is, when the permanent magnet 301 is arranged in the vicinity of the magnetic core 103, the permanent magnet 301 is assumed to interfere with the magnetic characteristics of the magnetic core 103 and cause a change in the inductance value. When the inductance value changes, even if the resonance frequency of the resonant circuit is selected to be equal to the frequency of the alternating current signal transmitted from the position detection device 10, 200, or 200A, the effective resonance frequency would change in association with the amount of change in the inductance value.

In view of this, there is a need to make the resonance frequency of the resonant circuit different from the resonance frequency in the case of including no permanent magnet 301, by taking into consideration in advance the amount of change in the inductance value of the magnetic core 103 caused by the permanent magnet 301.

Accordingly, making the resonance frequency of the resonant circuit different from the resonance frequency in the case of including no magnet can improve the position detection accuracy in the case where the pen is in the hovering state, while reserving the performance in the related art.

In the pen 100 according to the present embodiment, the permanent magnet 301 has anisotropy, and the integrated circuit detects the rotation of the permanent magnet 301. That is, if the permanent magnet 301 has anisotropy and the magnetic sensor 300 has sensitivity along one or more axes, the integrated circuit can decompose the values acquired by the magnetic sensor 300 into a plurality of axes and acquire the resultant values. Further, if the values from the magnetic sensor 300 decomposed into a plurality of axes are regarded as an amount of change corresponding to the passage of time, the integrated circuit can detect the rotation of the permanent magnet 301.

Accordingly, the position detection accuracy in the case where the pen is in the hovering state can be improved, while the performance in the related art is reserved.

In the pen 100 according to the present embodiment, the permanent magnet 301 has any one of a shape having a notch, a C shape, a polygonal shape, and a flat shape. That is, when the permanent magnet 301 is provided on an outer side of the casing 101, the permanent magnet 301 needs to have a C shape corresponding to the shape of the casing 101 or a shape having a notch so as not to drop off from the outer side of the casing 101.

In contrast, when the permanent magnet 301 is provided inside the casing 101, the permanent magnet 301 preferably has such a shape that the permanent magnet 301 is encapsulated in the casing 101 and the required magnetic force is reserved and hence needs to have a polygonal shape or a flat shape. That is, using the pen 100 in which the permanent magnet 301 having the abovementioned shape is provided inside or on the outer side of the casing 101 of the pen 100 makes it possible to improve the position detection accuracy in the case where the pen is in the hovering state, while reserving the performance in the related art.

In the pen 100 according to the present embodiment, the permanent magnet 301 is mounted on the outer side of the casing 101 of the pen 100 in a detachable manner. That is, the permanent magnet 301 is provided in a detachable manner on the outer side of the casing 101 of the pen 100, so that the permanent magnet 301 used for the pen 100 can, for example, be selected according to the purpose of use, required specification, and the like. Moreover, in a case where there is magnetic decay in the permanent magnet 301 or any other similar case, the permanent magnet 301 can easily be replaced.

Hence, the position detection accuracy in the case where the pen is in the hovering state can be improved while the performance in the related art is reserved.

The pen 100 according to the present embodiment includes a locking section that has a diameter different from the diameter of the casing 101 of the pen 100 on the outer side of the casing 101 of the pen 100 and that prevents the permanent magnet 301 from dropping off. Providing such a locking section allows the permanent magnet 301 to be physically fixed to the casing 101 of the pen 100, so that, even when a shock is applied to the pen 100, the permanent magnet 301 can be prevented from dropping off.

This makes it possible to improve the position detection accuracy in the case where the pen 100 is in the hovering state while reserving the performance of the position detection device 10, 200, or 200A in the related art, by maintaining the performance originally required of the pen 100.

### Fifth Embodiment

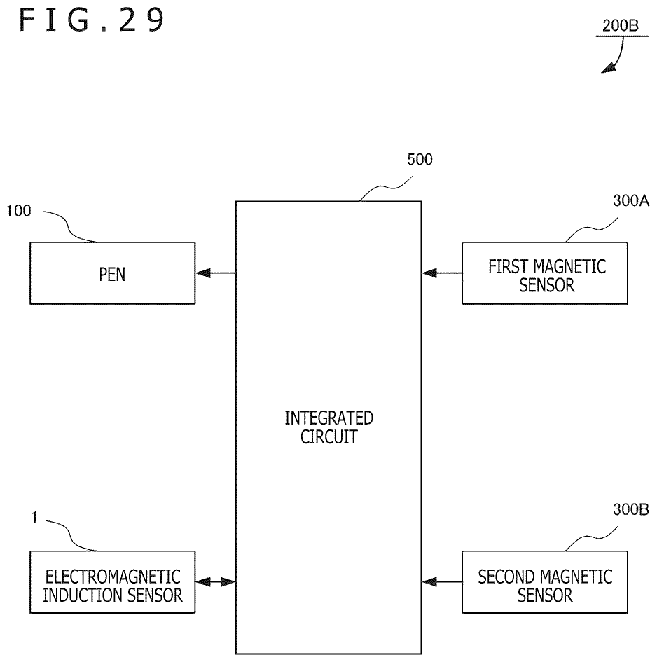

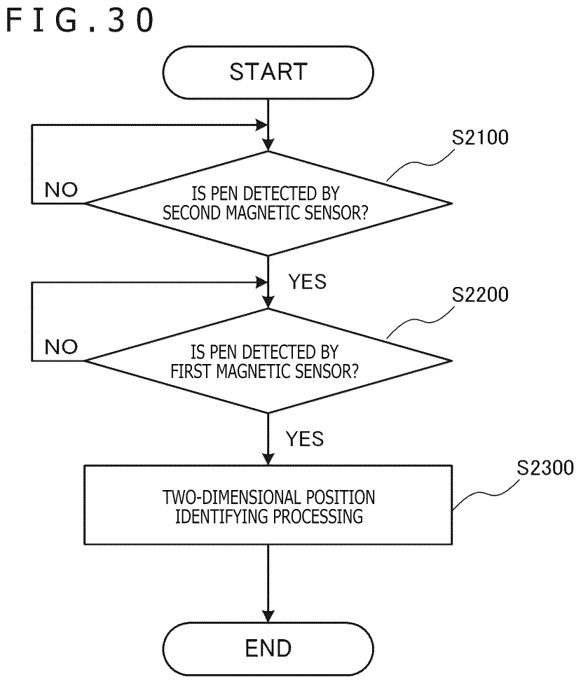

Next, a position detection device 200B according to a fifth embodiment of the present disclosure will be described with use of FIGS. 29 and 30.

### Configuration of Position Detection Device 200B

As illustrated in FIG. 29, the position detection device 200B according to the present embodiment includes the pen 100, the electromagnetic induction sensor 1, the first magnetic sensors 300A, a second magnetic sensor 300B, and an integrated circuit 500.

The pen 100 includes the resonant circuit and the permanent magnet 301 and outputs an alternating magnetic field as a pen signal. The electromagnetic induction sensor 1 includes a plurality of conducting wires including a plurality of electrodes arranged side by side in a first direction (X-axis direction) and a plurality of conducting wires including a plurality of electrodes arranged side by side in a second direction (Y-axis direction) intersecting the first direction (X-axis direction). The electromagnetic induction sensor 1 generates an alternating magnetic field, receives a pen signal that is a response alternating magnetic field from the pen 100, and acquires the level of the pen signal. The pen signal level is output to the integrated circuit 500 described later.

The plurality of first magnetic sensors 300A are provided in a detection area of the electromagnetic induction sensor 1 and capture the magnetic field generated by the permanent magnet 301 provided in the pen 100. The sensor output of the first magnetic sensors 300A is output to the integrated circuit 500 described later.

The second magnetic sensor 300B is provided in the vicinity of an outer periphery of the detection area of the electromagnetic induction sensor 1 and captures the magnetic field generated by the permanent magnet 301 provided in the pen 100. The sensor output of the second magnetic sensor 300B is output to the integrated circuit 500 described later.

The integrated circuit 500 generates position information of the pen 100 in the hovering HV state in the detection area of the electromagnetic induction sensor 1 by supplementarily using the output of one or more of the first magnetic sensors 300A that have detected the magnetic field generated by the permanent magnet 301 provided in the pen 100.

Moreover, the integrated circuit 500 generates position information of the pen 100 in the hovering HV state outside the detection area of the electromagnetic induction sensor 1 by supplementarily using the output of the second magnetic sensor 300B that has detected the magnetic field generated by the permanent magnet 301 provided in the pen 100.

Further, the integrated circuit 500 detects the alternating magnetic field generated by the pen 100 and identifies the two-dimensional position information of the pen 100.

### Processing in Position Detection Device 200B

The integrated circuit 500 determines whether the pen 100 has been captured, based on the output of the second magnetic sensor 300B (step S2100).

When determining based on the output of the second magnetic sensor 300B that the pen 100 has not been captured (“NO” in step S2100), the integrated circuit 500 returns the processing and transitions to the standby mode.

On the other hand, when determining based on the output of the second magnetic sensor 300B that the pen 100 has been captured (“YES” in step S2100), the integrated circuit 500 next determines whether the pen 100 has been captured, based on the output of one or more of the first magnetic sensors 300A (step S2200).

When determining based on the output of one or more of the first magnetic sensors 300A that the pen 100 has not been captured (“NO” in step S2200), the integrated circuit 500 returns the processing and transitions to the standby mode.

On the other hand, when determining based on the output of one or more of the first magnetic sensors 300A that the pen 100 has been captured (“YES” in step S2200), the integrated circuit 500 executes two-dimensional position identifying processing and generates coordinate information regarding the portion with which the pen tip of the pen 100 is in contact in the detection area of the electromagnetic induction sensor 1.

### Action and Effect

As described above, the position detection device 200B according to the present embodiment is a position detection device that detects the position of the pen 100, based on electromagnetic induction action. The pen 100 is provided with the permanent magnet 301 together with a coil that generates an alternating magnetic field. The position detection device 200B further includes the electromagnetic induction sensor 1 in which coil electrodes for detecting the alternating magnetic field generated by the pen 100, based on electromagnetic induction action, are arranged side by side, the plurality of first magnetic sensors 300A provided in the detection area of the electromagnetic induction sensor 1, the second magnetic sensor 300B provided in the vicinity of the outer periphery of the detection area of the electromagnetic induction sensor 1, and the integrated circuit 500 that executes the processing of detecting the alternating magnetic field generated by the pen 100 and identifying the two-dimensional position information of the pen 100 by supplementarily using the output of one or more of the first magnetic sensors 300A and the second magnetic sensor 300B that have detected the magnetic field generated by the permanent magnet 301.

That is, the integrated circuit 500 generates the position information of the pen 100 in the hovering HV state outside the detection area of the electromagnetic induction sensor 1 by supplementarily using the output of the second magnetic sensor 300B that has detected the magnetic field generated by the permanent magnet 301 provided in the pen 100, and also generates the position information of the pen 100 in the hovering HV state in the detection area of the electromagnetic induction sensor 1 by supplementarily using the output of one or more of the first magnetic sensors 300A that have detected the magnetic field generated by the permanent magnet 301 provided in the pen 100.

Further, the integrated circuit 500 detects the alternating magnetic field generated by the pen 100 and identifies the two-dimensional position information of the pen 100.

Hence, supplementarily using the output of the second magnetic sensor 300B makes it possible to capture the pen 100 that enters the detection area of the electromagnetic induction sensor 1 from the outside of the detection area of the electromagnetic induction sensor 1.

Accordingly, the pen 100 that enters the detection area of the electromagnetic induction sensor 1 from the outside of the detection area of the electromagnetic induction sensor 1 can be captured, so that the position detection accuracy for the pen 100 in the hovering state in the detection area of the electromagnetic induction sensor 1 can be improved at low cost.

### Modification 1

In the fourth embodiment, if the magnetic sensor 300 is a multi-axis magnetic sensor, the tilt of the pen 100 can also be detected. Hence, correcting the output value of the second magnetic sensor 300B on the position detection device 200B side by taking into consideration the tilt of the pen 100 makes it possible to capture the pen 100 from a relatively long distance outside the detection area of the electromagnetic induction sensor 1.

Moreover, utilizing the posture information of the pen 100 in a space outside the detection area of the electromagnetic induction sensor 1 makes it possible to predict the posture of the pen 100 at or after the time when the pen 100 enters the detection area of the electromagnetic induction sensor 1. Accordingly, acquiring the position information of the pen 100 in a space outside the detection area of the electromagnetic induction sensor 1 is expected to improve the position detection accuracy for the pen 100 in the hovering state, at low cost.

### Sixth Embodiment

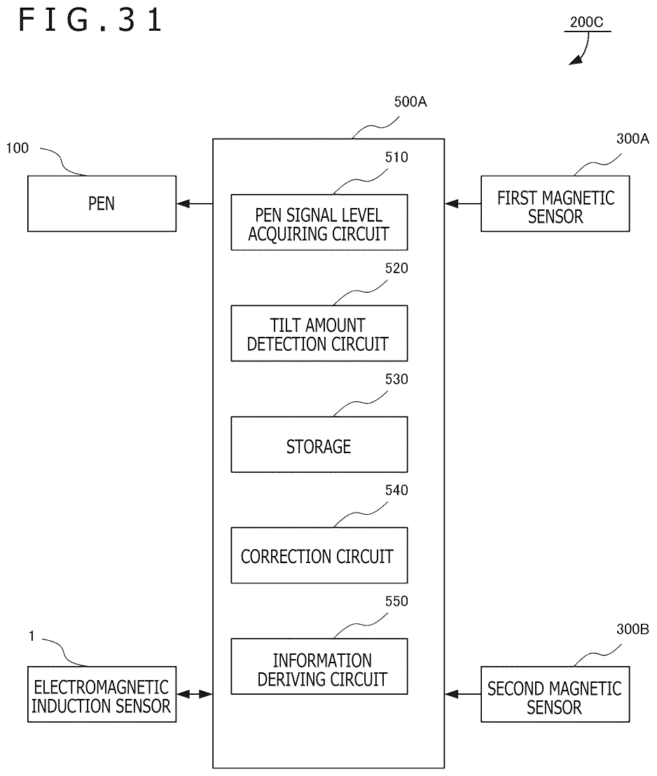

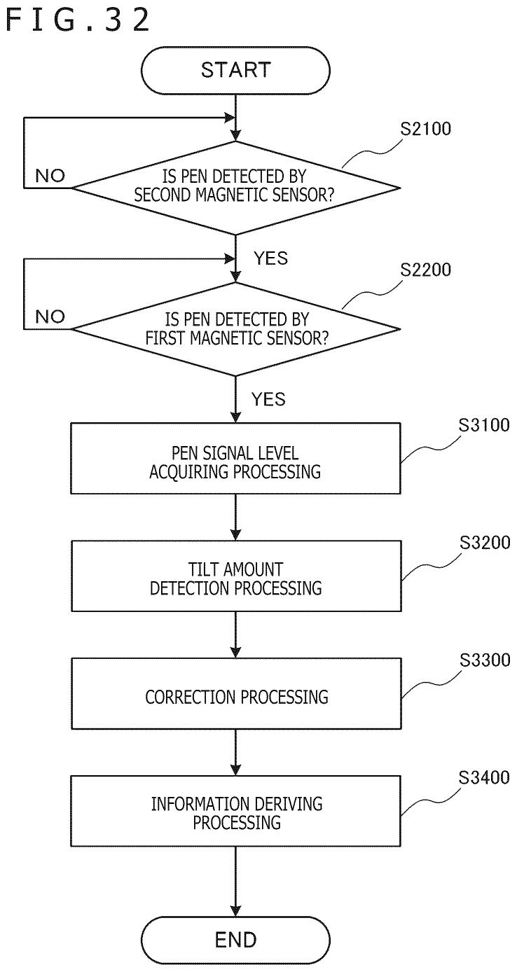

Next, a position detection device 200C according to a sixth embodiment of the present disclosure is described with use of FIGS. 31 and 32.

### Configuration of Position Detection Device 200C

As illustrated in FIG. 31, the position detection device 200C according to the present embodiment includes the pen 100, the electromagnetic induction sensor 1, the first magnetic sensors 300A, the second magnetic sensor 30B, and an integrated circuit 500A.

Note that components denoted by the same reference signs as those used in the firth embodiment have similar functions, and hence, the detailed explanation thereof is omitted.

### Configuration of Integrated Circuit 500A

As illustrated in FIG. 31, the integrated circuit 500A includes a pen signal level acquiring circuit 510, a tilt amount detection circuit 520, a storage 530, a correction circuit 540, and an information deriving circuit 550.

The pen signal level acquiring circuit 510 uses the electromagnetic induction sensor 1 to acquire the level of the pen signal that is a response alternating magnetic field from the pen 100. The pen signal level acquired by the pen signal level acquiring circuit 510 is sent out to an unillustrated control section in the integrated circuit 500A.

The tilt amount detection circuit 520 detects the title amount of the pen 100, based on the output values of one or more of the first magnetic sensors 300A. Specifically, for example, the tilt amount detection circuit 520 uses, as reference values, sensor output values along three axes that are obtained when the pen 100 is in a posture of facing the vertical direction relative to the electromagnetic induction sensor 1, and detects the tilt amount of the pen 100 by calculating a value difference between the reference values and the sensor output values along the three axes that have been acquired from one or more of the first magnetic sensors 300A.

The tilt amount of the pen 100 detected by the tilt amount detection circuit 520 is sent out to the unillustrated control section in the integrated circuit 500A.

The storage 530 stores a database in which the tilt amount and the correction amount for the pen signal are associated with each other.

The unillustrated control section in the integrated circuit 500A accesses the storage 530 at a necessary timing, reads the correction amount for the pen signal corresponding to the tilt amount, and sends out the correction amount to the correction circuit 540 described below.

The correction circuit 540 corrects the level of the pen signal, based on the correction amount for the pen signal corresponding to the tilt amount and the database stored in the storage 530. Information regarding the pen signal level corrected in the correction circuit 540 is sent out to the unillustrated control section in the integrated circuit 500A.

The information deriving circuit 550 derives position information of the pen 100, based on the corrected pen signal level. The information deriving circuit 550, for example, derives, as the position information of the pen 100, the coordinate information of the position indicating the highest pen signal level in the plane of the electromagnetic induction sensor 1.

### Processing in Position Detection Device 200C

The integrated circuit 500A determines whether the pen 100 has been captured, based on the output of the second magnetic sensor 300B (step S2100).

When determining based on the output of the second magnetic sensor 300B that the pen 100 has not been captured (“NO” in step S2100), the integrated circuit 500A returns the processing and transitions to the standby mode.

On the other hand, when determining based on the output of the second magnetic sensor 300B that the pen 100 has been captured (“YES” in step S2100), the integrated circuit 500A next determines whether the pen 100 has been captured, based on the output of one or more of the first magnetic sensors 300A (step S2200).

When determining based on the output of one or more of the first magnetic sensors 300A that the pen 100 has not been captured (“NO” in step S2200), the integrated circuit 500A returns the processing and transitions to the standby mode.

On the other hand, when determining based on the output of one or more of the first magnetic sensors 300A that the pen 100 has been captured (“YES” in step S2200), the integrated circuit 500A causes the pen signal level acquiring circuit 510 to execute pen signal level acquiring processing.

The pen signal level acquiring circuit 510 uses the electromagnetic induction sensor 1 to acquire the level of the pen signal that is a response alternating magnetic field from the pen 100, and sends out information regarding the acquired pen signal level to the unillustrated control section in the integrated circuit 500A (step S3100).

Next, the integrated circuit 500A causes the tilt amount detection circuit 520 to execute tilt amount detection processing. The tilt amount detection circuit 520 detects the tilt amount of the pen 100, based on the output values of one or more of the first magnetic sensors 300A, and sends out the detected tilt amount to the unillustrated control section in the integrated circuit 500A (step S3200).

The integrated circuit 500A causes the correction circuit 540 to execute correction processing. The correction circuit 540 corrects the level of the pen signal, based on the correction amount for the pen signal corresponding to the tilt amount and the pen signal level acquired by the pen signal level acquiring circuit 510, and sends out information regarding the corrected pen signal level to the unillustrated control section in the integrated circuit 500A (step S3300).

The integrated circuit 500A causes the information deriving circuit 550 to execute information deriving processing. The information deriving circuit 550 derives position information of the pen 100, based on the corrected pen signal level, and sends out the derived coordinate information to the unillustrated control section in the integrated circuit 500A (step S3400).

When the drawing operation performed by the user using the pen 100 is ended, all of the processing is ended.

### Action and Effect

As described above, the position detection device 200C according to the present embodiment is a position detection device that detects the position of the pen 100, based on electromagnetic induction action. The pen 100 is provided with the permanent magnet 301 together with a coil that generates an alternating magnetic field. The position detection device 200C further includes the electromagnetic induction sensor 1 in which coil electrodes for detecting the alternating magnetic field generated by the pen 100, based on electromagnetic induction action, are arranged side by side, the plurality of first magnetic sensor 300A provided in the detection area of the electromagnetic induction sensor 1, the second magnetic sensor 300B provided in the vicinity of the outer periphery of the detection area of the electromagnetic induction sensor 1, and the integrated circuit 500A that executes the processing of detecting the alternating magnetic field generated by the pen 100 and identifying the two-dimensional position information of the pen 100, by supplementarily using the output of one or more of the first magnetic sensors 300A and the second magnetic sensor 300B that have detected the magnetic field generated by the permanent magnet 301. The integrated circuit 500A includes the pen signal level acquiring circuit 510 that uses the electromagnetic induction sensor 1 to acquire the level of the pen signal that is a response alternating magnetic field from the pen 100, the tilt amount detection circuit 520 that detects the tilt amount of the pen 100, based on the output values of one or more of the first magnetic sensor 300A, the storage 530 that stores a database in which the tilt amount and the correction amount for the pen signal are associated with each other, the correction circuit 540 that corrects the pen signal level, based on the correction amount and the pen signal level that is acquired by the pen signal level acquiring circuit 510, and the information deriving circuit 550 that derives the position information of the pen 100, based on the corrected pen signal level.

That is, the integrated circuit 500A generates the position information of the pen 100 in the hovering HV state outside the detection area of the electromagnetic induction sensor 1 by supplementarily using the output of the second magnetic sensor 300B that has detected the magnetic field generated by the permanent magnet 301 provided in the pen 100, and also generates the position information of the pen 100 in the hovering HV state in the detection area of the electromagnetic induction sensor 1 by supplementarily using the output of one or more of the first magnetic sensors 300A that have detected the magnetic field generated by the permanent magnet 301 provided in the pen 100.

Further, the integrated circuit 500A causes the information deriving circuit 550 to detect the alternating magnetic field generated by the pen 100 and identify the two-dimensional position information of the pen 100.

Accordingly, supplementarily using the output of the second magnetic sensor 300B makes it possible to capture the pen 100 that enters the detection area of the electromagnetic induction sensor 1 from the outside of the detection area of the electromagnetic induction sensor 1.

Consequently, the pen 100 that enters the detection area of the electromagnetic induction sensor 1 from the outside of the detection area of the electromagnetic induction sensor 1 can be captured, so that the position detection accuracy for the pen 100 in the hovering state in the detection area of the electromagnetic induction sensor 1 can be improved at low cost.

Moreover, the position detection device 200C according to the present embodiment acquires the level of the pen signal that is a response alternating magnetic field from pen 100, detects the tilt amount of the pen 100, based on the output values of one or more of the first magnetic sensors 300A, identifies the correction amount from the database in which the tilt amount and the correction amount for the pen signal are associated with each other, corrects the pen signal level, and derives the position information of the pen 100, based on the corrected pen signal level.

Hence, highly accurate position information can be derived regardless of the posture of the pen 100.

### Seventh Embodiment

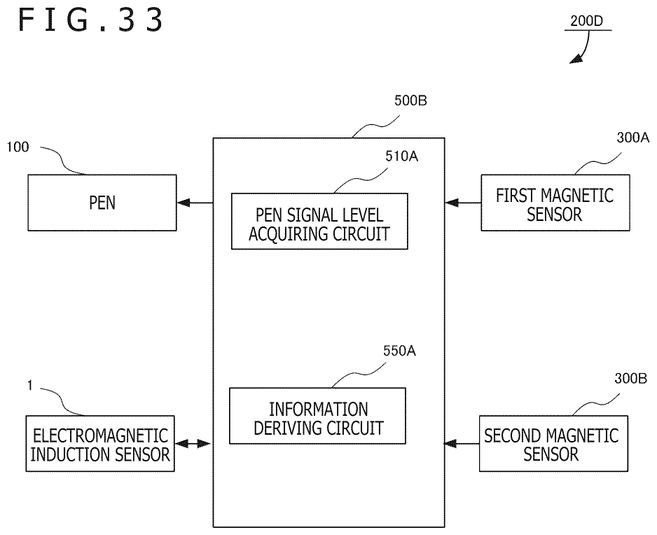

Next, a position detection device 200D according to a seventh embodiment of the present disclosure will be described with use of FIGS. 33 through 39C.

### Configuration of Position Detection Device 200D

As illustrated in FIG. 33, the position detection device 200D according to the present embodiment includes the pen 100, the electromagnetic induction sensor 1, the first magnetic sensors 300A, the second magnetic sensor 300B, and an integrated circuit 500B.

Note that components denoted by the same reference signs as those in the fifth and sixth embodiments have similar functions, and hence, the detailed explanation thereof is omitted.

### Configuration of Integrated Circuit 500B

As illustrated in FIG. 33, the integrated circuit 500B includes a pen signal level acquiring circuit 510A and an information deriving circuit 550A.

The pen signal level acquiring circuit 510A uses the electromagnetic induction sensor 1 to acquire the level of the pen signal that is a response alternating magnetic field from the pen 100. Specifically, the pen signal level acquiring circuit 510A detects the pen signal level value in an area where a TX sensor coil T1 and RX sensor coils R1 through R4, constituting part of the electromagnetic induction sensor 1, cross (hereinafter referred to as a coil cross point area) and obtains the signal levels at respective coil cross points, that is, generates two-dimensional heatmap data RXdata, by sequentially changing the selection of the TX sensor coil.

The information deriving circuit 550A uses the two-dimensional distribution of pen signal levels and derives information regarding the position of the pen 100. Specifically, the information deriving circuit 550A derives either the tilt of the pen 100 relative to the normal to the sensor plane or the direction of the tilt of the pen 100 relative to the sensor plane, based on the asymmetric nature of the two-dimensional distribution.

The information deriving circuit 550A acquires a first reference position that is a position indicated by the pen tip of the pen 100, acquires a second reference position that is protruding upwardly or downwardly, and derives the direction of the tilt of the pen 100 relative to the sensor plane, based on the direction of the second reference position relative to the first reference position. The information deriving circuit 550A derives the tilt of the pen 100 relative to the normal to the sensor plane, based on the pen signal level strength at the first reference position and the pen signal level strength at the second reference position.

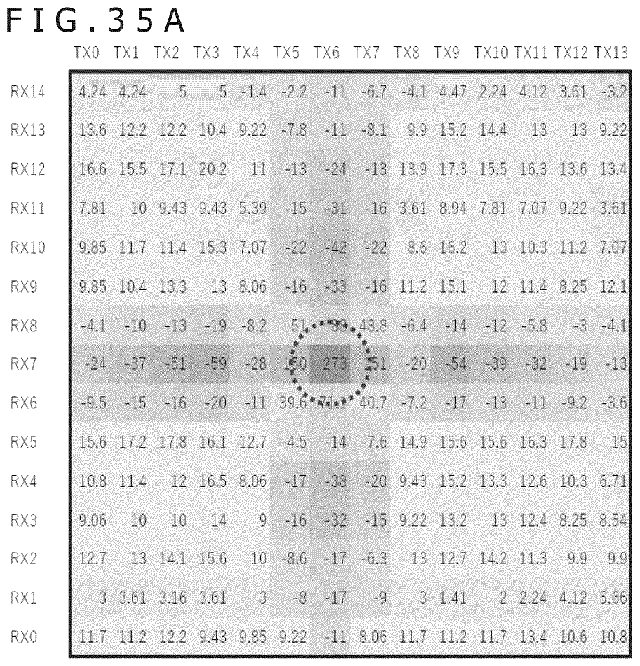

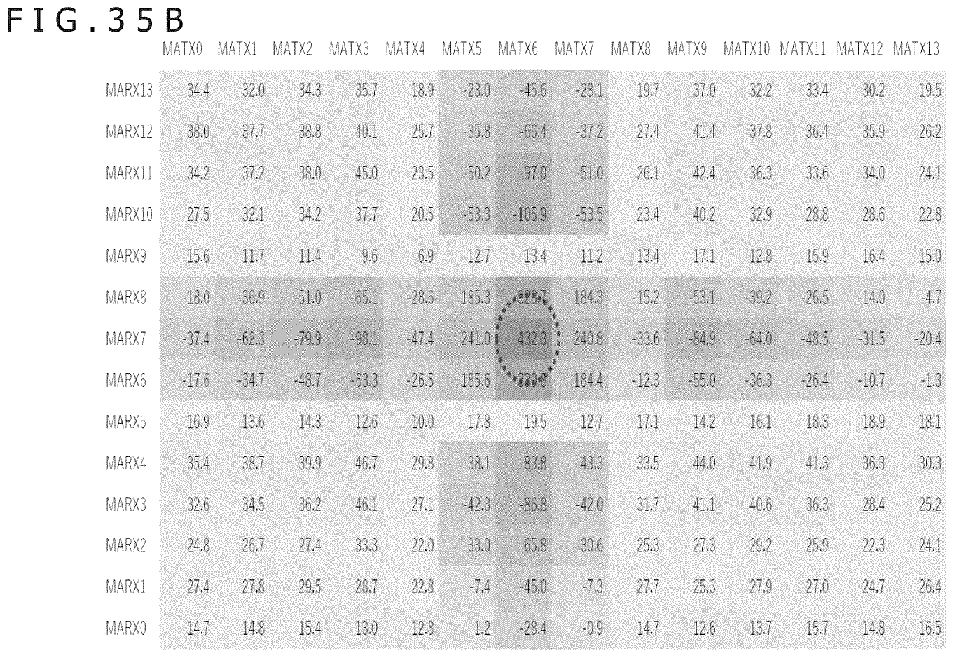

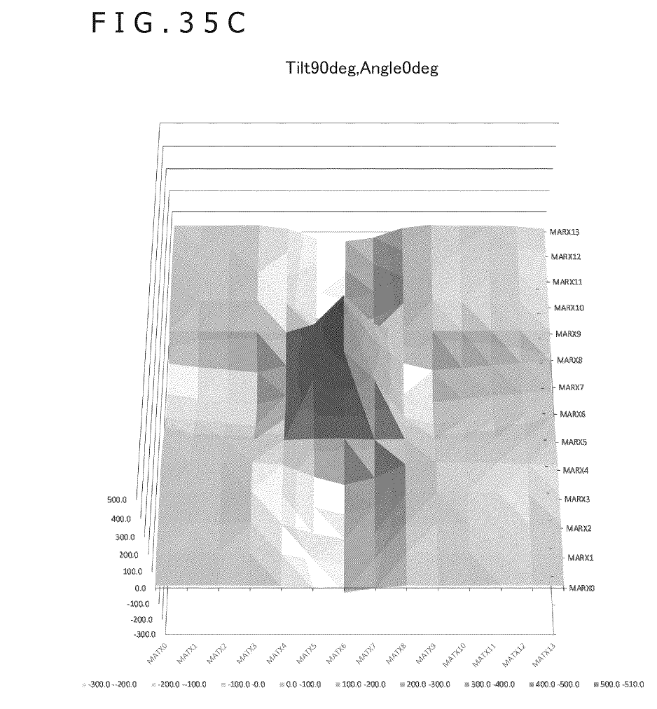

Here, FIGS. 35A, 36A, 37A, 38A, and 39A are each map data obtained by converting the pen signal levels at the positions where the RX sensor coils R0 through R15 and the TX sensor coils TO through T15 cross on the sensor plane of the electromagnetic induction sensor 1 into numerical values, FIGS. 35B, 36B, 37B, 38B, and 39B are each data obtained by organizing the pieces of data illustrated in FIGS. 35A, 36A, 37A, 38A, and 39A by the moving average, and FIGS. 35C, 36C, 37C, 38C, and 39C are each a graph obtained by converting FIGS. 35B, 36B, 37B, 38B, and 39B into 3D data.

FIGS. 35A through 35C illustrate level changes in a case where the tilt (tilt angle) of the pen relative to the normal to the sensor plane is 90 degrees and the direction (angle) of the tilt of the pen relative to the sensor plane is 0 degrees. In FIG. 35A, a peak value is exhibited at (TX6, RX7), while in FIG. 35B, a peak value is exhibited at (MATX6, MARX7), and similar changes in the pen signal level appear concentrically. FIG. 35C also indicates a similar state.

FIGS. 35A and 35B illustrate that (TX6, RX7) or (MATX6, MARX7) is the first reference position which is a position indicated by the pen tip of the pen.

The method of deriving the tilt (tilt angle) of the pen relative to the normal to the sensor plane and the direction (angle) of the tilt of the pen relative to the sensor plane in this case is similar to that in the related art, and hence would not be detailed.

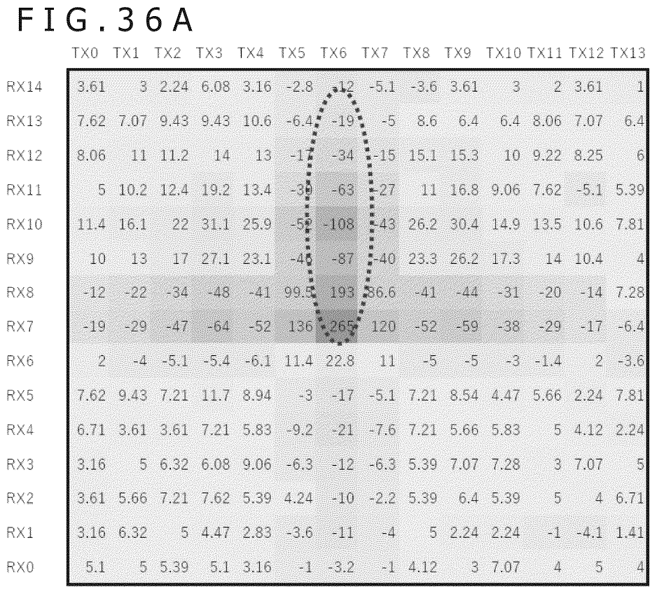

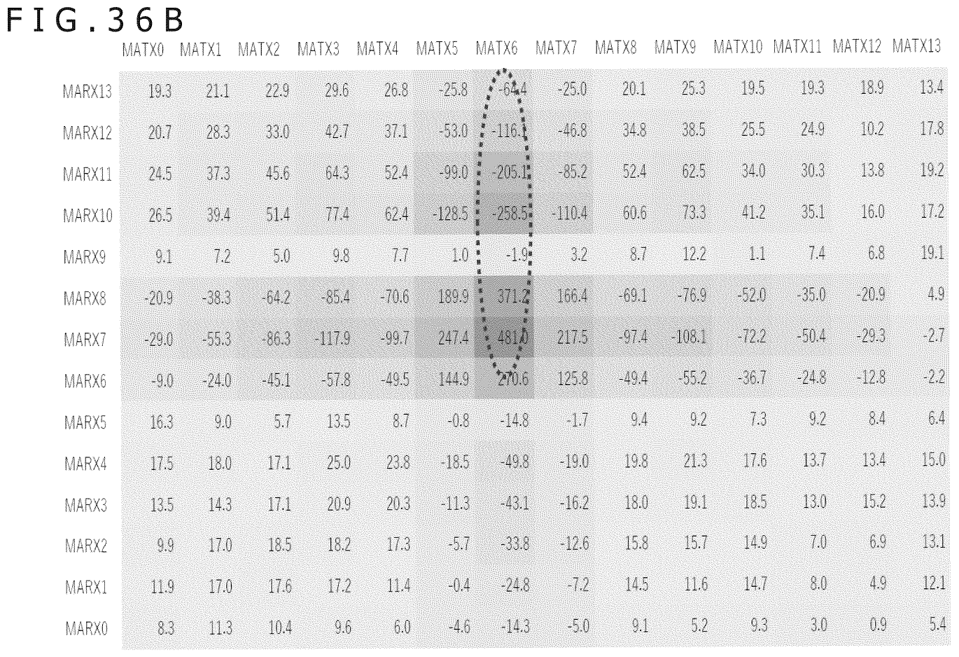

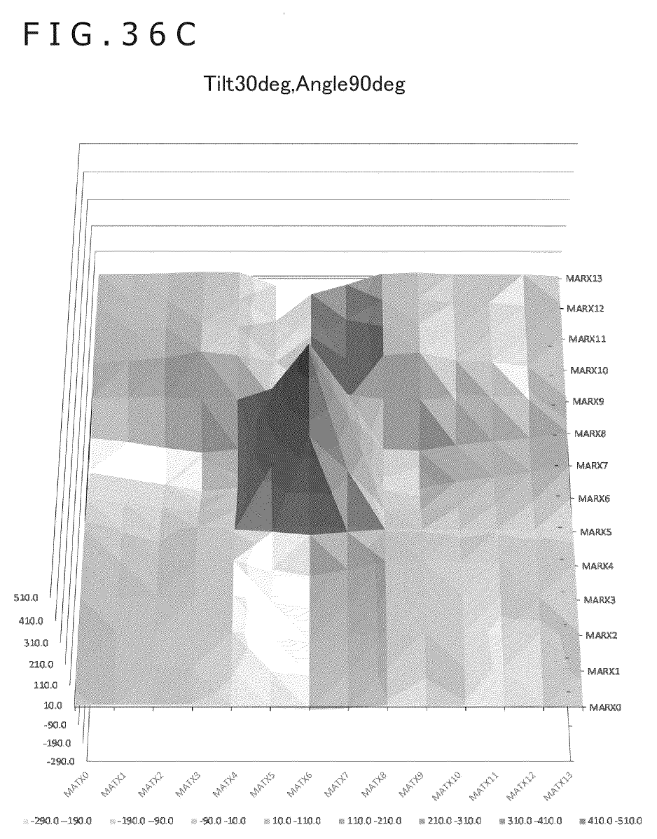

FIGS. 36A through 36C illustrate level changes in a case where the tilt (tilt angle) of the pen relative to the normal to the sensor plane is 30 degrees and the direction (angle) of the tilt of the pen relative to the sensor plane is 90 degrees.

In FIG. 36A, a peak value is exhibited at (TX6, RX7), while in FIG. 36B, a peak value is exhibited at (MATX6, MARX7), and the pen signal levels are changing significantly in a direction of going upward from the peak values. FIG. 36C also indicates a similar state. FIGS. 36A and 36B illustrate that (TX6, RX7) or (MATX6, MARX7) is the first reference position which is a position indicated by the pen tip of the pen.

The method of deriving the tilt (tilt angle) of the pen relative to the normal to the sensor plane and the direction (angle) of the tilt of the pen relative to the sensor plane in this case is similar to that in the related art, and hence would not be detailed.

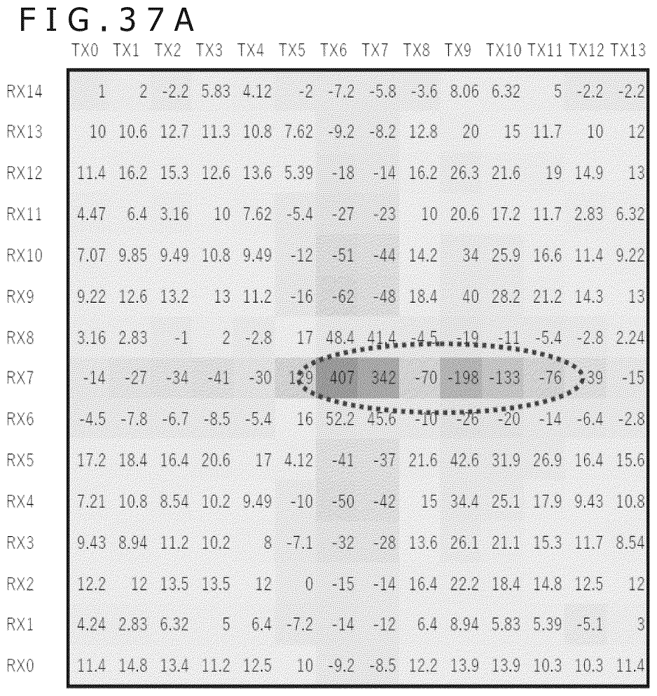

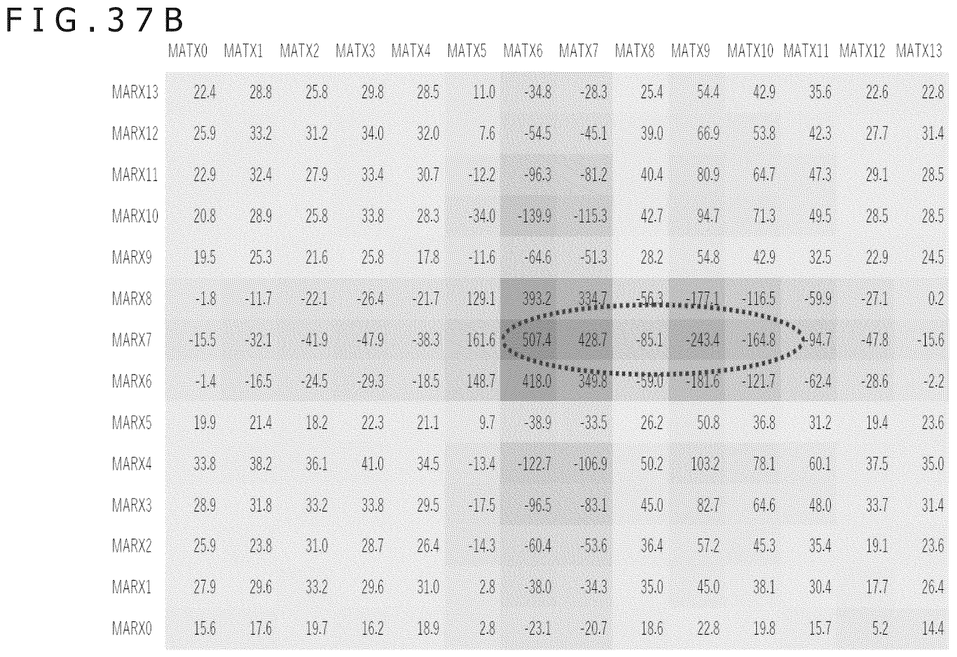

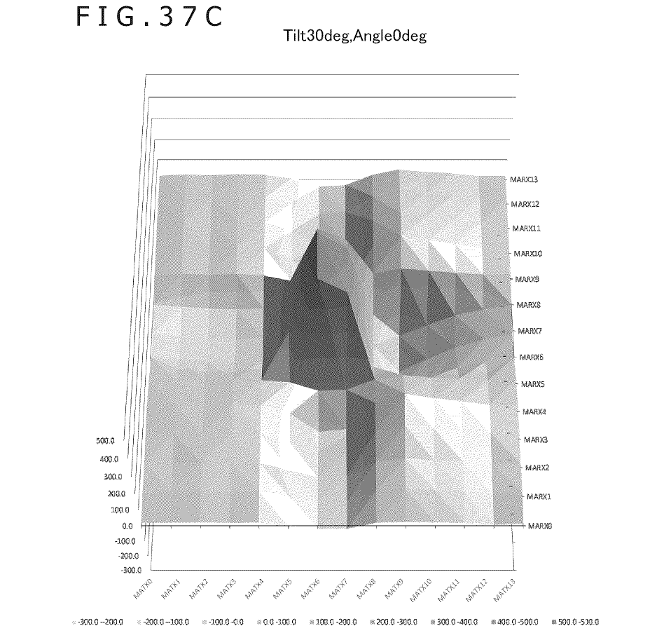

FIGS. 37A through 37C illustrate level changes in a case where the tilt (tilt angle) of the pen relative to the normal to the sensor plane is 30 degrees and the direction (angle) of the tilt of the pen relative to the sensor plane is 0 degrees.

In FIG. 37A, a peak value is exhibited at (TX6, RX7), while in FIG. 37B, a peak value is exhibited at (MATX6, MARX7), and the pen signal levels are changing significantly in a direction of going rightward from the peak values. FIG. 37C also indicates a similar state.

FIGS. 37A and 37B illustrate that (TX6, RX7) or (MATX6, MARX7) is the first reference position which is a position indicated by the pen tip of the pen.

The method of deriving the tilt (tilt angle) of the pen relative to the normal to the sensor plane and the direction (angle) of the tilt of the pen relative to the sensor plane in this case is similar to that in the related art, and hence would not be detailed.

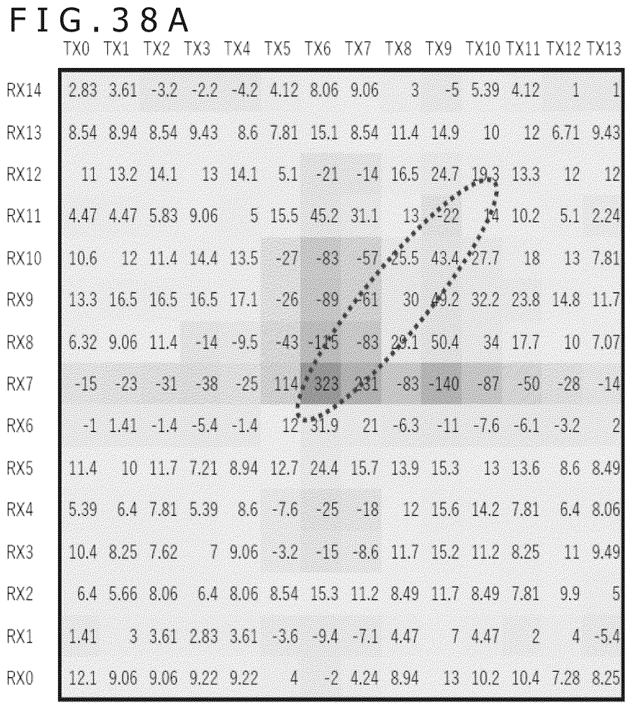

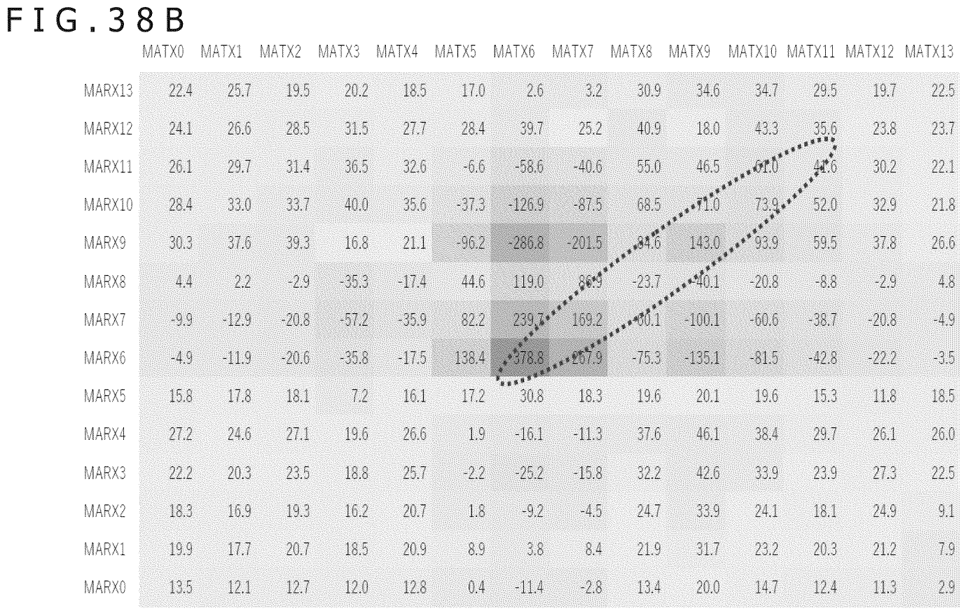

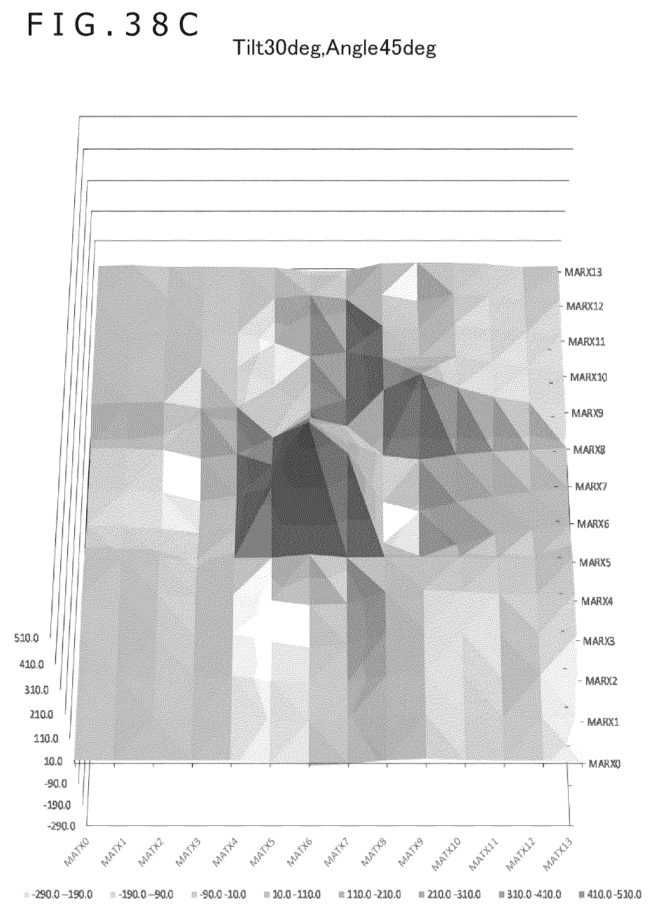

FIGS. 38A through 38C illustrate level changes in a case where the tilt (tilt angle) of the pen relative to the normal to the sensor plane is 30 degrees and the direction (angle) of the tilt of the pen relative to the sensor plane is 45 degrees.

In FIG. 38B, a peak value is exhibited at (MATX6, MATX7), and this point is the first reference position which is a position indicated by the pen tip of the pen. Moreover, in FIG. 38B, a second peak value is exhibited at (MATX9, MARX9), and this point is the second reference position.

The information deriving circuit of an RX circuit 20 acquires the first reference position which is a position indicated by the pen tip of the pen, acquires the second reference position which is protruding upwardly or downwardly, and derives the direction of the tilt of the pen relative to the sensor plane, based on the direction of the second reference position relative to the first reference position.

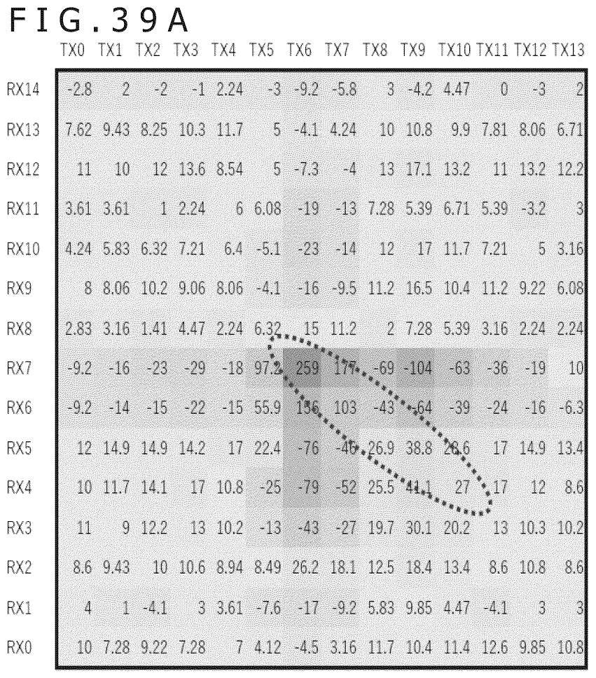

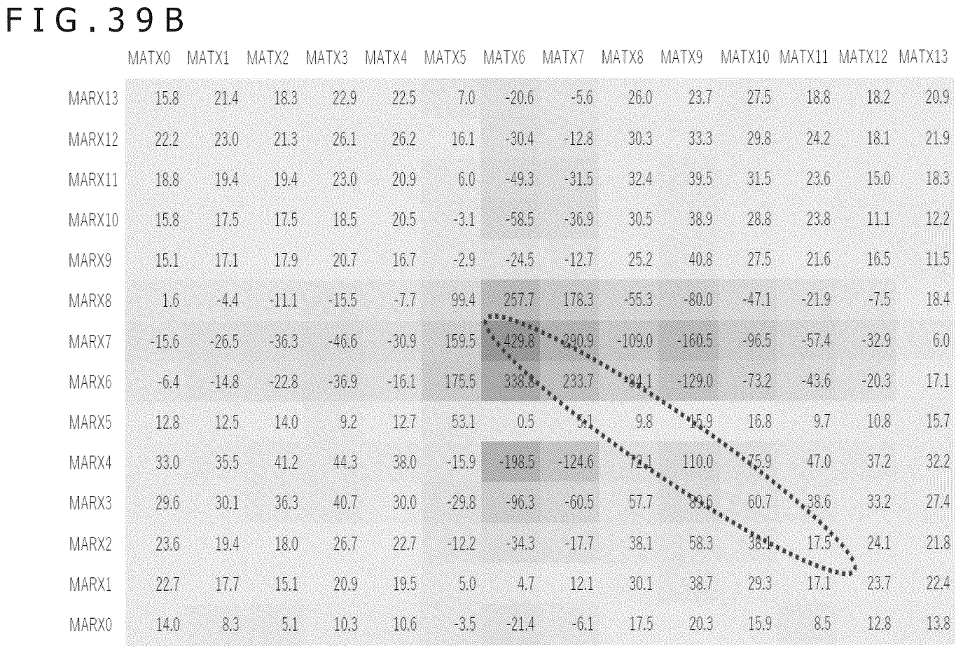

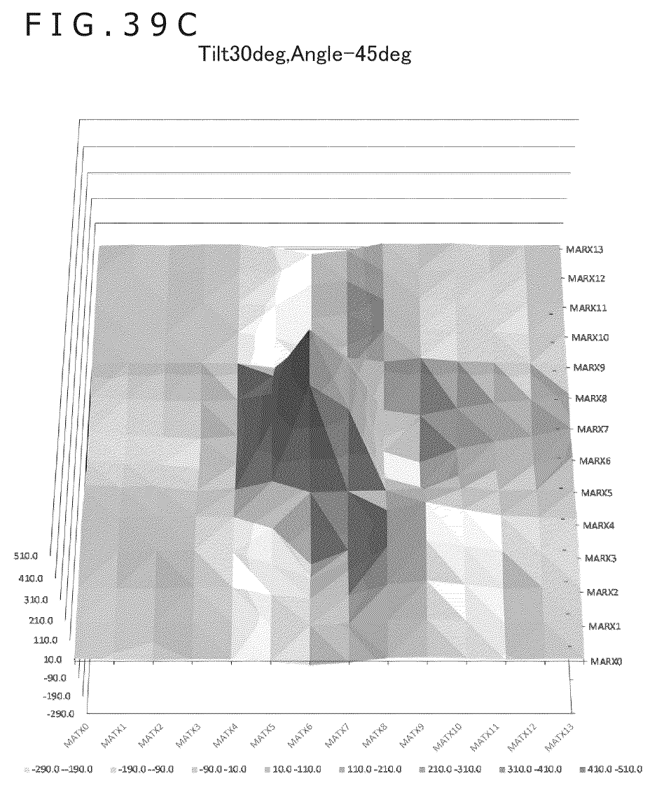

FIGS. 39A through 39C illustrate level changes in a case where the tilt (tilt angle) of the pen relative to the normal to the sensor plane is 30 degrees and the direction (angle) of the tilt of the pen relative to the sensor plane is −45 degrees.

In FIG. 39B, a peak value is exhibited at (MATX6, MARX7), and this point is the first reference position which is a position indicated by the pen tip of the pen. Moreover, in FIG. 39B, a second peak value is exhibited at (MATX9, MARX4), and this point is the second reference position.

The information deriving circuit of the RX circuit 20 acquires the first reference position which is a position indicated by the pen tip of the pen, acquires the second reference position which is protruding upwardly or downwardly, and derives the direction of the tilt of the pen relative to the sensor plane, based on the direction of the second reference position relative to the first reference position.

The information deriving circuit 550A executes the process in the coordinate processing and derives the pen coordinate, the pen tilt (angle from the normal relative to the sensor plane), or the pen orientation (tilted angle), based on the two-dimensional heatmap data RXdata generated in the pen signal level acquiring circuit 510A, after acquiring the two-dimensional heatmap data RXdata.

### Processing in Position Detection Device 200D

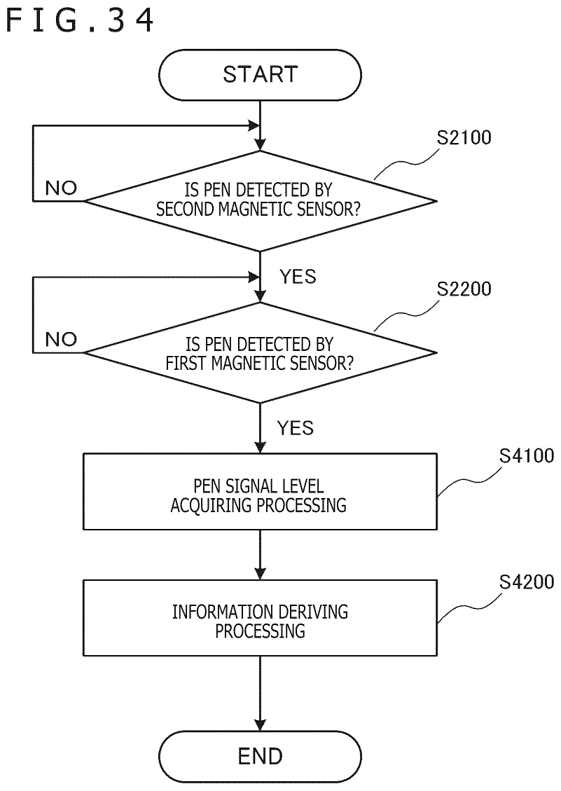

Next, processing in the position detection device 200D according to the present embodiment will be described with use of FIG. 34.

The integrated circuit 500B determines whether the pen 100 has been captured, based on the output of the second magnetic sensor 300B (step S2100).

When determining based on the output of the second magnetic sensor 300B that the pen 100 has not been captured (“NO” in step S2100), the integrated circuit 500B returns the processing and transitions to the standby mode.

On the other hand, when determining based on the output of the second magnetic sensor 300B that the pen 100 has been captured (“YES” in step S2100), the integrated circuit 500B next determines whether the pen 100 has been captured, based on the output of one or more of the first magnetic sensors 300A (step S2200).

When determining based on the output of one or more of the first magnetic sensors 300A that the pen 100 has not been captured (“NO” in step S2200), the integrated circuit 500B returns the processing and transitions to the standby mode.

On the other hand, when determining based on the output of one or more of the first magnetic sensors 300A that the pen 100 has been captured (“YES” in step S2200), the integrated circuit 500B causes the pen signal level acquiring circuit 510A to execute the pen signal level acquiring processing.

The pen signal level acquiring circuit 510A uses the electromagnetic induction sensor 1 to acquire the level of the pen signal that is a response alternating magnetic field from the pen 100 and generates two-dimensional heatmap data RXdata (step S4100).

The integrated circuit 500B causes the information deriving circuit 550A to execute the information deriving processing.

The information deriving circuit 550A executes the process in the coordinate processing and derives the pen coordinate, the pen tilt (angle from the normal relative to the sensor plane), or the pen orientation (tilted angle), based on the two-dimensional heatmap data RXdata generated in the pen signal level acquiring circuit 510A, after acquiring the two-dimensional heatmap data RXdata (step S4200).

When the drawing operation performed by the user using the pen 100 is ended, all of the processing is ended.

### Modification 2

The abovementioned embodiment has illustrated that the second magnetic sensor 300B provided in the vicinity of the outer periphery of the detection area of the electromagnetic induction sensor 1 is used to capture the pen 100 that enters the detection area of the electromagnetic induction sensor 1 from the outside of the detection area of the electromagnetic induction sensor 1 and that the process in the coordinate processing is executed to derive the pen coordinate, the pen tilt (angle from the normal relative to the sensor plane), or the pen orientation (tilted angle), based on the two-dimensional heatmap data RXdata generated in the pen signal level acquiring circuit 510A, after the two-dimensional heatmap data RXdata has been acquired.

The present modification proposes to use the plurality of first magnetic sensors 300A provided in the detection area of the electromagnetic induction sensor 1 and obtain the coordinates in a case where the pen 100 in the hovering HV state is projected on the touch surface, by causing the pen signal level acquiring circuit 510A that is to originally operate when the pen 100 comes into contact with the touch surface to operate when the pen 100 has entered the detection area of the electromagnetic induction sensor 1 and is in the hovering HV state.

This makes it possible to more accurately acquire the coordinate information in the case where the pen 100 in the hovering HV state is projected on the touch surface than in the related art, so that more accurate position information can be derived regardless of the posture of the pen 100.

### Action and Effect

As described above, the position detection device 200D according to the present embodiment is a position detection device that detects the position of the pen 100, based on electromagnetic induction action. The pen 100 is provided with the permanent magnet 301 together with the coil that generates an alternating magnetic field. The position detection device 200D further includes the electromagnetic induction sensor 1 in which coil electrodes for detecting the alternating magnetic field generated by the pen 100, based on electromagnetic induction action, are arranged side by side, the plurality of first magnetic sensors 300A provided in the detection area of the electromagnetic induction sensor 1, the second magnetic sensor 300B provided in the vicinity of the outer periphery of the detection area of the electromagnetic induction sensor 1, and the integrated circuit 500B that executes the processing of detecting the alternating magnetic field generated by the pen 100 and identifying the two-dimensional position information of the pen 100, by supplementarily using the output of one or more of the first magnetic sensors 300A and the second magnetic sensor 300B that have detected the magnetic field generated by the permanent magnet 301. The integrated circuit 500B includes the pen signal level acquiring circuit 510A that uses the electromagnetic induction sensor 1 to acquire the level of the pen signal that is a response alternating magnetic field from the pen 100 and the information deriving circuit 550A that derives information regarding the position of the pen 100, by using the two-dimensional distribution of the pen signal levels.

Here, specifically, the information deriving circuit 550A executes the process in the coordinate processing and derives the pen coordinate, the pen tilt (the angle from the normal relative to the sensor plane), or the pen orientation (tilted angle), based on the two-dimensional heatmap data RXdata generated in the pen signal level acquiring circuit 510A, after acquiring the two-dimensional heatmap data RXdata.

That is, the integrated circuit 500B generates the position information of the pen 100 in the hovering HV state outside the detection area of the electromagnetic induction sensor 1 by supplementarily using the output of the second magnetic sensor 300B that has detected the magnetic field generated by the permanent magnet 301 provided in the pen 100, and also generates the position information of the pen 100 in the hovering HV state in the detection area of the electromagnetic induction sensor 1 by supplementarily using the output of one or more of the first magnetic sensors 300A that have detected the magnetic field generated by the permanent magnet 301 provided in the pen 100.

The integrated circuit 500B further detects the alternating magnetic field generated by the pen 100 and identifies the two-dimensional position information of the pen 100. Hence, supplementarily using the output of the second magnetic sensor 300B makes it possible to capture the pen 100 that enters the detection area of the electromagnetic induction sensor 1 from the outside of the detection area of the electromagnetic induction sensor 1.

Accordingly, the pen 100 entering the detection area of the electromagnetic induction sensor 1 from the outside of the detection area of the electromagnetic induction sensor 1 can be captured, so that the position detection accuracy for the pen 100 in the hovering state in the detection area of the electromagnetic induction sensor 1 can be improved at low cost.

Further, the position detection device 200D according to the present embodiment executes the process in the coordinate processing and derives the pen coordinate, the pen tilt (angle from the normal relative to the sensor plane), or the pen orientation (tilted angle), based on the two-dimensional heatmap data RXdata generated in the pen signal level acquiring circuit 510A, after acquiring the two-dimensional heatmap data RXdata. Hence, highly accurate position information can be derived regardless of the posture of the pen 100.

Moreover, highly accurate position information can be derived regardless of the posture of the pen 100 by easy and simple processing.

Note that the position detection devices 10, 200, and 200A through 200D according to the embodiments of the present disclosure can be implemented by recording the processing to be executed by the integrated circuit 500A or 500B in a recording medium which is readable by a computer system, having the integrated circuit 500A or 500B read the program recorded in the recording medium, and executing the program. The computer system referred to here includes an operating system (OS) and hardware such as a peripheral device.

Moreover, the “computer system” also includes a website providing environment (or a website displaying environment) when the world wide web (WWW) system is used.

Further, the abovementioned program may be transmitted from the computer system in which the program is stored in the storage device or the like to another computer system via a transmitting medium or by a carrier wave in the transmitting medium. Here, the “transmitting medium” that transmits the program refers to a medium that has a function of transmitting information as exemplified by a network (communication network) such as the Internet or a communication line (communication line) such as a telephone line.

Further, the abovementioned program may be one for implementing some of the functions described above. Moreover, the program may be what is generally called a differential file (differential program) that can implement the functions in combination with the programs that have already been recorded in the computer system.

The embodiments of the present disclosure have been described in detail above with reference to the drawings. All of the position detection devices that can be implemented by those skilled in the art through appropriate design modifications based on the position detection devices 10, 200, and 200A through 200D that have been described as embodiments of the present disclosure fall within the technical scope of the present disclosure as long as the position detection devices contain the gist of the present invention.

It should be understood that those skilled in the art would arrive at various kinds of modifications and corrections within the scope of the technical idea of the present disclosure and such modifications and corrections also fall within the technical scope of the present invention.

For example, those which have been obtained by those skilled in the art by adding or deleting the components or changing the design of the components or adding or omitting steps or changing the conditions for the steps as needed with respect to the embodiments also fall within the technical scope of the present disclosure as long as they include the gist of the present invention.

Moreover, other actions and effects that are offered by the modes described in the embodiments and that are obvious from the description in the present specification or that can be arrived at by those skilled in the art as appropriate are understood as being naturally offered by the present invention.

Various kinds of inventions can be formed by an appropriate combination of the plurality of components disclosed in the embodiments.

For example, some components may be deleted from all the components illustrated in the embodiment.

Moreover, components covering different embodiments can be combined as appropriate.

### Supplement 1

Provided is a position detection device that detects a position of a pen, based on electromagnetic induction action, in which the pen is provided with a permanent magnet together with a coil that generates an alternating magnetic field, the position detection device includes one or a plurality of processors, one or a plurality of memories connected to the one or the plurality of processors in a manner allowing communication therebetween, an electromagnetic induction sensor in which coil electrodes for detecting the alternating magnetic field generated by the pen, based on electromagnetic induction action, are arranged side by side, and a plurality of first magnetic sensors provided in the electromagnetic induction sensor, and the processor executes processing of detecting the alternating current magnetic field generated by the pen and identifying two-dimensional position information of the pen, by supplementarily using output of one or more of the first magnetic sensors that have detected the magnetic field generated by the permanent magnet.

### Supplement 2

Provided is a position detection device that detects a position of a pen, based on electromagnetic induction action, in which the pen is provided with a permanent magnet together with a coil that generates an alternating magnetic field, the position detection device includes one or a plurality of processors, one or a plurality of memories that are connected to the one or the plurality of processors in a manner allowing communication therebetween, an electromagnetic induction sensor in which coil electrodes for detecting the alternating magnetic field generated by the pen, based on electromagnetic induction action, are arranged side by side, a plurality of first magnetic sensors provided in the electromagnetic induction sensor, and a second magnetic sensor provided in a vicinity of an outer periphery of a detection area of the electromagnetic induction sensor, and the processor executes processing of detecting the alternating magnetic field generated by the pen and identifying two-dimensional position information of the pen, by supplementarily using output of one or more of the first magnetic sensors that have detected the magnetic field generated by the permanent magnet. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A position detection device comprising:
an electromagnetic induction sensor including coil electrodes that detect an alternating magnetic field generated by a pen, based on electromagnetic induction action; and
a plurality of magnetic sensors.

2. The position detection device according to claim 1, wherein the magnetic sensors are provided at positions where the magnetic sensors do not overlap the coil electrodes in plan view.

3. The position detection device according to claim 1, wherein the magnetic sensors are provided at positions where the magnetic sensors are not affected by a magnetic field generated by a current flowing through the coil electrodes.

4. The position detection device according to claim 1, wherein the electromagnetic induction sensor and the magnetic sensors are mounted on an electromagnetic induction sensor substrate.

5. The position detection device according to claim 4, wherein the magnetic sensors are provided at positions where the magnetic sensors do not overlap the coil electrodes in plan view.

6. The position detection device according to claim 4, wherein
a magnetic sheet is stacked on a lower portion of the electromagnetic induction sensor substrate, and
the magnetic sheet is provided with through holes at portions corresponding to positions where the magnetic sensors are mounted in plan view.

7. The position detection device according to claim 1, wherein an electromagnetic induction sensor substrate on which the electromagnetic induction sensor is mounted and a magnetic sensor substrate on which the magnetic sensors are mounted are different substrates.

8. The position detection device according to claim 7, wherein
the electromagnetic induction sensor substrate, a magnetic sheet, and the magnetic sensor substrate are stacked in this order from top to bottom, and
the magnetic sheet is provided with through holes at portions corresponding to positions where the magnetic sensors are mounted on the magnetic sensor substrate in plan view.

9. The position detection device according to claim 7, wherein the magnetic sensor substrate, the electromagnetic induction sensor substrate, and a magnetic sheet are stacked in this order from top to bottom.

10. The position detection device according to claim 4, wherein a signal wire, a ground wire, and a power supply wire from the electromagnetic induction sensor and a signal wire, a ground wire, and a power supply wire from the magnetic sensors are routed to a same layer in the electromagnetic induction sensor substrate.

11. The position detection device according to claim 10, wherein the ground wire from the electromagnetic induction sensor and the ground wire from the magnetic sensors are shared.

12. A position detection device that detects a position of a pen, based on electromagnetic induction action, wherein
the pen is provided with a permanent magnet together with a coil that generates an alternating magnetic field; and
the position detection device includes
an electromagnetic induction sensor in which coil electrodes for detecting the alternating magnetic field generated by the pen, based on electromagnetic induction action, are arranged side by side,
a plurality of first magnetic sensors provided in the electromagnetic induction sensor, and
an integrated circuit that detects the alternating magnetic field generated by the pen and identifies two-dimensional position information of the pen by supplementarily using output of one or more of the first magnetic sensors that have detected a magnetic field generated by the permanent magnet.

13. The position detection device according to claim 12, wherein
a detection of the output of the one or more first magnetic sensors is used for determining whether the pen is present in a predetermined detection space, and
an identification of the two-dimensional position information is executed based on the alternating magnetic field detected by the electromagnetic induction sensor.

14. The position detection device according to claim 13, wherein, in a case where magnetism is detected by the one or more first magnetic sensors, the integrated circuit turns on a global scan mode.

15. The position detection device according to claim 14, wherein, in a case where a state in which position information of the pen is unacquirable continues for a predetermined period of time even when the global scan mode is turned on, the integrated circuit turns off the global scan mode.

16. The position detection device according to claim 13, wherein
the integrated circuit includes a notifying circuit that issues a message to a user, and
the integrated circuit changes a scan mode, according to an amount of change in output detection values of the one or more of the first magnetic sensors, when the notifying circuit issues a message for rotating a main body to a user and causes the user rotate the main body.

17. The position detection device according to claim 12, wherein the integrated circuit performs determination of distinguishing between a change in geomagnetism and a change associated with approach of the permanent magnet and detecting approach of the permanent magnet.

18. The position detection device according to claim 17, wherein
the plurality of first magnetic sensors are arranged at predetermined intervals, and
the integrated circuit determines how many of the plurality of first magnetic sensors arranged at the predetermined intervals have detected a change in a predetermined magnetic field.

19. The position detection device according to claim 18, wherein the predetermined intervals are greater than intervals of arrangement of the coil electrodes.

20. The position detection device according to claim 17, wherein the integrated circuit regards the geomagnetism as a vector, uses a magnitude of a change in the geomagnetism along an X-axis, a Y-axis, and a Z-axis as a norm of the vector, and monitors the change in the norm to perform distinguishment and determination on a change associated with the geomagnetism and the change associated with approach of the permanent magnet.

21. The position detection device according to claim 20, wherein the integrated circuit executes the distinguishment and determination, based on a result obtained by performing operation processing on output values from the plurality of first magnetic sensors.

22. The position detection device according to claim 17, wherein
the integrated circuit includes a storage that stores a detection value that has been detected at a certain timing by each of the plurality of first magnetic sensors, and
the integrated circuit executes distinguishment and determination by executing operation processing on, among the detection values stored in the storage, at least the detection value detected at a certain timing by one of the first magnetic sensors and the detection value most recently detected by the one first magnetic sensor.

23. The position detection device according to claim 22, wherein the integrated circuit executes the distinguishment and determination, based on variation in the output values of the first magnetic sensors.

24. The position detection device according to claim 22, wherein, when there is no predetermined variation in the output values of the first magnetic sensors, the integrated circuit rewrites the detection values stored in the storage to the detection values subsequently obtained.

25. The position detection device according to claim 12, wherein the pen is provided with the permanent magnet arranged at a position rearwardly separated from the coil in an axial direction.

26. The position detection device according to claim 25, wherein the permanent magnet is arranged inside a casing of the pen and rearward of the coil in the axial direction.

27. The position detection device according to claim 12, wherein a magnetism shielding member is arranged between the coil and the permanent magnet.

28. The position detection device according to claim 12, wherein
the pen includes a resonant circuit, and
a resonance frequency of the resonant circuit is different from a resonance frequency in a pen including no magnet.

29. The position detection device according to claim 12, wherein
the permanent magnet has anisotropy, and
the integrated circuit detects rotation of the permanent magnet.

30. The position detection device according to claim 12, wherein the permanent magnet has at least one of a shape having a notch, a C shape, a polygonal shape, and a flat shape.

31. The position detection device according to claim 12, wherein the permanent magnet is mounted on an outer side of a casing of the pen in a detachable manner.

32. The position detection device according to claim 12, wherein a locking section that has a diameter different from a diameter of a casing of the pen and that prevents the permanent magnet from dropping off is provided on an outer side of the casing of the pen.

33. A position detection device that detects a position of a pen, based on electromagnetic induction action, wherein
the pen is provided with a permanent magnet together with a coil that generates an alternating magnetic field; and
the position detection device includes
an electromagnetic induction sensor in which coil electrodes for detecting the alternating magnetic field generated by the pen, based on electromagnetic induction action, are arranged side by side,
a plurality of first magnetic sensors provided in a detection area of the electromagnetic induction sensor,
a second magnetic sensor provided in a vicinity of an outer periphery of the detection area of the electromagnetic induction sensor, and
an integrated circuit that detects the alternating magnetic field generated by the pen and identifies two-dimensional position information of the pen by supplementarily using output of one or more of the first magnetic sensors and the second magnetic sensor that have detected a magnetic field generated by the permanent magnet.

34. The position detection device according to claim 33, wherein
the integrated circuit includes
a pen signal level acquiring circuit that uses the electromagnetic induction sensor to acquire a level of a pen signal that is a response alternating magnetic field from the pen,
a tilt amount detection circuit that detects a tilt amount of the pen, based on output values of the one or more first magnetic sensors,
a storage that stores a database in which the tilt amount and a correction amount for the pen signal are associated with each other,
a correction circuit that corrects the level of the pen signal, based on the correction amount and the pen signal level acquired by the pen signal level acquiring circuit, and
an information deriving circuit that derives position information of the pen, based on the corrected level of the pen signal.

35. The position detection device according to claim 33, further comprising:
a pen signal level acquiring circuit that uses the electromagnetic induction sensor to acquire a level of a pen signal that is a response alternating magnetic field from the pen, and
an information deriving circuit that derives information regarding a position of the pen, by using two-dimensional distribution of levels of the pen signal.

36. A sensor comprising:
an electromagnetic induction sensor including coil electrodes that detect an alternating magnetic field generated by a pen, based on electromagnetic induction action; and
a plurality of magnetic sensors.

37. A pen comprising:
a coil that generates an alternating magnetic field; and
a permanent magnet.
